(19) United States
(12) Patent Application Publication
(10) Pub. No.: US 2026/0081647 A1
(43) Pub. Date: Mar. 19, 2026

(54) TECHNIQUES FOR TRANSMITTING WITH A LOW-RESOLUTION CONDITION OR A HIGH-RESOLUTION CONDITION

(71) Applicant: Lenovo (United States) Inc., Morrisville, NC (US)

(72) Inventors: Seyedomid Taghizadeh Motlagh, Oberursel (DE); Karthikeyan Ganesan, Kronberg im Taunus (DE); Ali Ramadan Ali, Kraiburg am Inn (DE)

(21) Appl. No.: 18/885,521

(22) Filed: Sep. 13, 2024

(51) Int. Cl. H04B 7/0417; H04B 7/0408; H04B 7/06; H04W 24/10

(52) U.S. Cl. CPC H04B 7/0417; H04B 7/0408; H04B 7/0626; H04W 24/10

(57) ABSTRACT

Various aspects of the present disclosure relate to transmitting a first signal via a first beam and a second signal via a second beam, the first bean associated with the LR transmit condition and the second beam associated with an HR transmit condition. The transmission of the second signal may be after the transmission of the first signal, where the second beam is associated with the HR transmit condition based on a first response associated with the transmitted first signal. The transmission of the first signal may be after the transmission of the second signal, where the first beam is associated with the LR transmit condition based on a second response associated with the transmitted second signal. The first beam may be associated with the LR transmit condition irrespective of whether the second beam is associated with the HR transmit condition.

### TECHNICAL FIELD

The present disclosure relates to wireless communications, and more specifically to techniques for transmitting a first signal via a first beam associated with a low-resolution (LR) condition or transmitting a second signal via a second beam associated with a high-resolution (HR) condition.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

Some implementations of the method and apparatuses described herein may transmit a first signal via a first beam associated with a low-resolution (LR) transmit condition and transmit a second signal via a second beam associated with a high-resolution (HR) transmit condition. In such implementations, the second signal may be transmitted after the first signal is transmitted and the second beam is associated with the HR transmit condition based at least in part on a first response associated with the first signal, or the first signal may be transmitted after the second signal and the first beam is associated with the LR transmit condition based at least in part on a second response associated with the second signal, or the first signal and the second signal are transmitted simultaneously, the first beam is associated with the LR transmit condition based at least in part on the second beam being associated with the HR transmit condition or irrespective of whether the second beam is associated with the HR transmit condition.

### BRIEF DESCRIPTION OF THE DRAWINGS

FIG. 1 illustrates an example of a wireless communications system in accordance with aspects of the present disclosure.

FIG. 2 illustrates an example of a protocol stack, in accordance with aspects of the present disclosure.

FIG. 3A illustrates an example of a multiple-input multiple-output (MIMO) architecture with an LR radio array, in accordance with aspects of the present disclosure.

FIG. 3B illustrates another example of a MIMO architecture with an LR radio array, in accordance with aspects of the present disclosure.

FIG. 4A illustrates an example of a MIMO architecture with an LR radio array with analog beamforming, in accordance with aspects of the present disclosure.

FIG. 4B illustrates another example of a MIMO architecture with an LR radio array with analog beamforming, in accordance with aspects of the present disclosure.

FIG. 5A illustrates an example of a MIMO architecture with an LR radio array with hybrid digital and analog beamforming, in accordance with aspects of the present disclosure.

FIG. 5B illustrates an example of a MIMO architecture with an LR radio array with hybrid digital and analog beamforming, in accordance with aspects of the present disclosure.

FIG. 6 illustrates an example of a communication scenario between a first radio node and a second radio node, in accordance with aspects of the present disclosure.

FIG. 7A illustrates an example of a quasi-co-location (QCL) relation between two or more beams, in accordance with aspects of the present disclosure.

FIG. 7B illustrates another example of a QCL relation between two or more beams, in accordance with aspects of the present disclosure.

FIG. 7C illustrates yet another example of a QCL relation between two or more beams, in accordance with aspects of the present disclosure.

FIG. 7D illustrates still another example of a QCL relation between two or more beams, in accordance with aspects of the present disclosure.

FIG. 7E illustrates a further example of a QCL relation between two or more beams, in accordance with aspects of the present disclosure.

FIG. 8 illustrates an example of a UE in accordance with aspects of the present disclosure.

FIG. 9 illustrates an example of a processor in accordance with aspects of the present disclosure.

FIG. 10 illustrates an example of a network equipment (NE) in accordance with aspects of the present disclosure.

FIG. 11 illustrates a flowchart of a method performed by a NE in accordance with aspects of the present disclosure.

### DETAILED DESCRIPTION

In a wireless communications system, a UE and a NE (e.g., a base station, gNB) may support wireless communication (e.g., reception and/or transmission of wireless communication) using time-frequency resources. To convert a digital signal (e.g., from the baseband domain) to an analog signal for transmission, a digital-to-analog converter (DAC) is used. Likewise, to convert a received analog signal to an analog signal for processing by the baseband domain, an analog-to-digital converter (ADC) is used.

DACs are utilized at different nodes of a wireless communication system to enable wireless communication using time-frequency resources, including at the UE and NE. For instance, DACs are used in the analog front-end (AFE) of transceivers to handle high-speed data conversion, enabling efficient transmission and reception of signals. Some DACs are integrated into system-on-chip (SoC) designs for wireless transceivers and can support different frequency bands including sub-6 GHZ (FR1) and millimeter-wave (FR2) frequency bands.

DACs can account for a significant percentage of energy consumption at different nodes of a wireless communication system. However, due to a substantially lower complexity, cost, and energy consumption, low resolution (LR) DACs show potential for reduced link energy consumption as well as to facilitate up-scaling of a number of digital chains, which can reduce the per-chain component cost.

Traditionally, the DACs and ADCs are high resolution (HR), meaning they utilize the highest level of quantization supported by the hardware. In contrast, an LR DAC, for instance, represents a DAC that is configured to utilize much fewer quantization steps than does a higher-resolution DAC. For example, when link performance is not dominated by the quantization resolution (e.g., in high resolution DAC scenarios), the utilization of a beam and/or radio chain with LR DAC can result in an improved energy efficiency.

Nevertheless, realizing potential gains of LR radios may involve modifying steps associated with channel estimation of a wireless link associated with an LR radio, channel equalization of the link terminated at an LR radio, as well as link adaptation (e.g., transmit (Tx) power and modulation and coding scheme (MCS) adjustments for the link associated with an LR radio) in light of the non-linear LR quantization effect that may result from utilizing LR DACs.

In particular, utilization of an LR DAC can lead to additional Tx quantization distortion for transmission of modulated data and control information as well as degraded channel estimation and equalization. These effects can occur, for example, when variations on standard reference signal (RS) transmission and generation are used, e.g., the downlink (DL) channel state information (CSI)-RS or DL physical downlink shared channel (PDSCH) demodulation reference signal (DMRS) modulated over a cyclic prefix orthogonal frequency division multiplexing (CP-OFDM) waveform. In particular, the aforementioned RS generation schemes can be prone to additive quantization distortions when quantized with LR DACs and can lead to a degraded channel estimation and equalization quality.

Considering a wireless communication between a first radio node including at least a LR radio chain/beam and a second radio node, it is of interest to determine a transmission occasion or beam of the first radio node among the plurality of the HR and/or LR beams of the first radio node. It is also of interest to define how to perform channel estimation and/or Rx beam determination for the second radio node associated with an LR Tx beam of the first radio node.

Aspects of the present disclosure are described in the context of a wireless communications system and include implementations that provide solutions that can determine and/or select a transmission occasion or beam of the first radio node among the plurality of the HR and/or LR beams of the first radio node. For a first radio node transmitting one or more beams associated with an HR status and at least one or more beams associated with an LR status and a second radio node receiving the transmission of the first radio node via the beams, aspects of the present disclosure describe indicating (e.g., to the second radio node) a Tx beam with an LR status.

Aspects of the present disclosure also describe indicating an association of a Tx HR beam with a Tx LR beam. For example, a particular Tx LR beam may be associated with one or more of: an HR beam, a second LR beam; jointly with multiple HR beams, jointly with one LR beam and one HR beam. As used herein, an LR beam refers to a beam for transmission or reception that is associated with an LR status. As used herein, an HR beam refers to a beam for transmission or reception that is associated with an HR status.

For example, aspects of the present disclosure include transmitting (e.g., to the second radio node) a configuration for measurement, reporting, selection of a transmission beam/occasion associated with an LR transmit condition by the second radio node including a first set of parameters for the beams with HR status and a second set of parameters for the beams with LR status. For example, the first and second sets of parameters may include different reporting thresholds for the beams with HR status than for beams with LR status. As another example, the first and second sets of parameters may include different measurement sorting criteria for the beams with HR status than for beams with LR status, i.e., at least a first criterion for ordering measurements associated with beams of HR status and a second criterion for ordering measurements associated with beams of LR status, where the first criterion is different than the second criterion. Implementations that provide solutions for performing channel estimation and/or Rx beam determination for the second radio node associated with an LR Tx beam of the first radio node.

By performing the described techniques, devices in a wireless communications system can utilize LR radios (e.g., LR DACs) for wireless communication while minimizing effects of LR radio utilization on signal quality. Thus, energy usage can be conserved while mitigating the effects of such energy conservation on signal quality.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

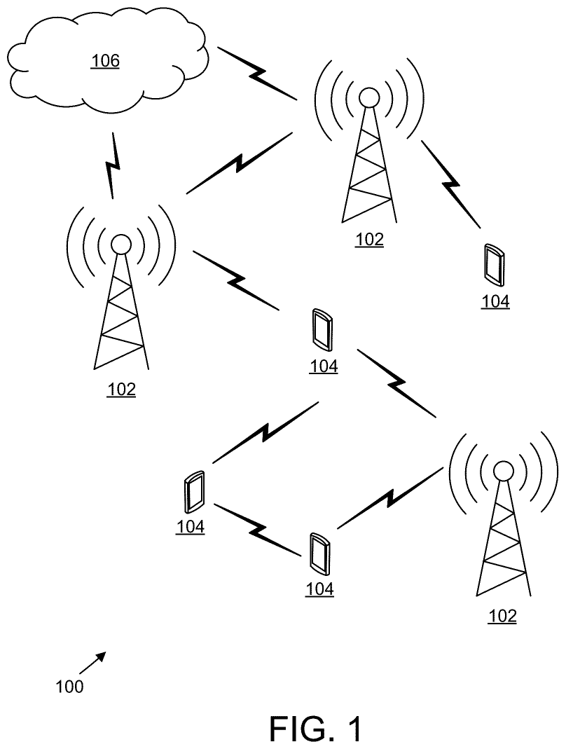

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as a Long-Term Evolution (LTE) network or an LTE-Advanced (LTE-A) network. In some other implementations, the wireless communications system 100 may be a New Radio (NR) network, such as a 5G network, a 5G-Advanced (5G-A) network, or a 5G ultrawideband (5G-UWB) network.

In other implementations, the wireless communications system 100 may be a combination of a 4G network and a 5G network, or other suitable radio access technology (RAT) including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an internet-of-things (IoT) device, an internet-of-everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N3, or network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management function (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signaling bearers, etc.) for the one or more UEs 104 served by the one or more NE 102 associated with the CN 106.

The CN 106 may communicate with a packet data network over one or more backhaul links (e.g., via an S1, N2, N3, or another network interface). The packet data network may include an application server. In some implementations, one or more UEs 104 may communicate with the application server. A UE 104 may establish a session (e.g., a protocol data unit (PDU) session, or a PDN connection, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively.

Each slot may include a number (e.g., quantity) of symbols (e.g., orthogonal frequency domain multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHZ-24.25 GHZ), FR4 (52.6 GHz-114.25 GHZ), FR4a or FR4-1 (52.6 GHZ-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the NEs 102 and the UEs 104 are operable to implement various aspects of the techniques described with reference to the present disclosure.

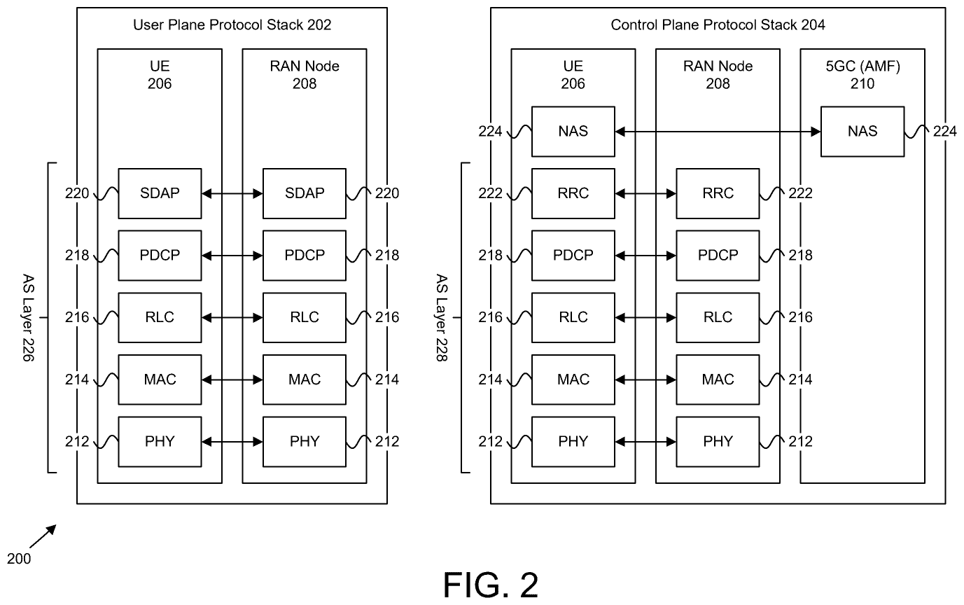

FIG. 2 illustrates an example of a protocol stack 200, in accordance with aspects of the present disclosure. While FIG. 2 shows a UE 206, a RAN node 208, and a 5G core network (5GC) 210 (e.g., comprising at least an AMF), these are representative of a set of UEs 104 interacting with an NE 102 (e.g., base station) and a CN 106. As depicted, the protocol stack 200 comprises a user plane protocol stack 202 and a control plane protocol stack 204. The user plane protocol stack 202 includes a physical (PHY) layer 212, a medium access control (MAC) sublayer 214, a radio link control (RLC) sublayer 216, a packet data convergence protocol (PDCP) sublayer 218, and a service data adaptation protocol (SDAP) sublayer 220. The control plane protocol stack 204 includes a PHY layer 212, a MAC sublayer 214, a RLC sublayer 216, and a PDCP sublayer 218. The control plane protocol stack 204 also includes a radio resource control (RRC) layer 222 and a NAS layer 224.

Note that in some transparent satellite architectures, the satellite may act as a repeater, but does not terminate the NR-Uu interface. In some embodiments, the NTN may relay signaling for one or more layers between the UE 206 and the RAN node 208. In other embodiments, the NTN may relay NAS layer signaling between the RAN node 208 and the 5GC 210 (note that NAS singling is transparent to the RAN node 208).

The AS layer 226 (also referred to as “AS protocol stack”) for the user plane protocol stack 202 consists of at least SDAP, PDCP, RLC and MAC sublayers, and the physical layer. The AS layer 228 for the control plane protocol stack 204 consists of at least RRC, PDCP, RLC and MAC sublayers, and the physical layer. The layer-1 (L1) includes the PHY layer 212. The layer-2 (L2) is split into the SDAP sublayer 220, PDCP sublayer 218, RLC sublayer 216, and MAC sublayer 214. The layer-3 (L3) includes the RRC layer 222 and the NAS layer 224 for the control plane and includes, e.g., an internet protocol (IP) layer and/or PDU Layer (not depicted) for the user plane. L1 and L2 are referred to as “lower layers,” while L3 and above (e.g., transport layer, application layer) are referred to as “higher layers” or “upper layers.”

The PHY layer 212 offers transport channels to the MAC sublayer 214. The PHY layer 212 may perform a beam failure detection procedure using energy detection thresholds, as described herein. In certain embodiments, the PHY layer 212 may send an indication of beam failure to a MAC entity at the MAC sublayer 214. The MAC sublayer 214 offers logical channels to the RLC sublayer 216. The RLC sublayer 216 offers RLC channels to the PDCP sublayer 218. The PDCP sublayer 218 offers radio bearers to the SDAP sublayer 220 and/or RRC layer 222. The SDAP sublayer 220 offers QoS flows to the core network (e.g., 5GC). The RRC layer 222 manages the addition, modification, and release of carrier aggregation and/or dual connectivity. The RRC layer 222 also manages the establishment, configuration, maintenance, and release of signaling radio bearers (SRBs) and data radio bearers (DRBs).

The NAS layer 224 is between the UE 206 and an AMF in the 5GC 210. NAS messages are passed transparently through the RAN. The NAS layer 224 is used to manage the establishment of communication sessions and for maintaining continuous communications with the UE 206 as it moves between different cells of the RAN. In contrast, the AS layers 226 and 228 are between the UE 206 and the RAN (i.e., RAN node 208) and carry information over the wireless portion of the network. While not depicted in FIG. 2, the IP layer exists above the NAS layer 224, a transport layer exists above the IP layer, and an application layer exists above the transport layer.

The MAC sublayer 214 is the lowest sublayer in the L2 architecture of the NR protocol stack. Its connection to the PHY layer 212 below is through transport channels, and the connection to the RLC sublayer 216 above is through logical channels. The MAC sublayer 214 therefore performs multiplexing and demultiplexing between logical channels and transport channels: the MAC sublayer 214 in the transmitting side constructs MAC PDUs (also known as transport blocks (TBs)) from MAC service data units (SDUs) received through logical channels, and the MAC sublayer 214 in the receiving side recovers MAC SDUs from MAC PDUs received through transport channels.

In the radio protocol architectures described herein, the term “SDU” refers to a data unit that is received by a sublayer from a higher sublayer, or that is sent by a sublayer to a higher sublayer. Likewise, the term “PDU” refers to a data unit that is sent by a sublayer to a lower sublayer, or that is received by a sublayer from a lower sublayer.

The MAC sublayer 214 provides a data transfer service for the RLC sublayer 216 through logical channels, which are either control logical channels which carry control data (e.g., RRC signaling) or traffic logical channels which carry user plane data. On the other hand, the data from the MAC sublayer 214 is exchanged with the PHY layer 212 through transport channels, which are classified as uplink (UL) or downlink (DL). Data is multiplexed into transport channels depending on how it is transmitted over the air.

The PHY layer 212 is responsible for the actual transmission of data and control information via the air interface, i.e., the PHY layer 212 carries all information from the MAC transport channels over the air interface on the transmission side. Some of the important functions performed by the PHY layer 212 include coding and modulation, link adaptation (e.g., adaptive modulation and coding (AMC)), power control, cell search and random access (for initial synchronization and handover purposes) and other measurements (inside the Third Generation Partnership Project (3GPP) system (i.e., NR and/or LTE system) and between systems) for the RRC layer 222. The PHY layer 212 performs transmissions based on transmission parameters, such as the modulation scheme, the coding rate (i.e., the modulation and coding scheme (MCS)), the number of physical resource blocks (PRBs), etc.

In some embodiments, the protocol stack 200 may be an NR protocol stack used in a 5G NR system. Note that an LTE protocol stack comprises similar structure to the protocol stack 200, with the differences that the LTE protocol stack lacks the SDAP sublayer 220 in the AS layer 226, that an EPC replaces the 5GC 210, and that the NAS layer 224 is between the UE 206 and an MME in the EPC. Also note that the present disclosure distinguishes between a protocol layer (such as the aforementioned PHY layer 212, MAC sublayer 214, RLC sublayer 216, PDCP sublayer 218, SDAP sublayer 220, RRC layer 222 and NAS layer 224) and a transmission layer in multiple-input multiple-output (MIMO) communication (also referred to as a “MIMO layer” or a “data stream”).

Regarding beam management in NR, beam management is defined as a set of L1 and/or L2 procedures to acquire and maintain a set of beam pair links, i.e., a beam used at transmit-receive point(s) (TRP(s)) for base station (BS) side paired with a beam used at the UE 206. The beam pair links can be used for DL and UL transmission/reception. The beam management procedures include at least the following six aspects: 1) Beam sweeping; 2) Beam measurement; 3) Beam reporting; 4) Beam determination; 5) Beam maintenance; and 6) Beam recovery.

Beam sweeping refers to the operation of covering a spatial area by transmitting via multiple beam each beam pointing in a different spatial direction, with beams transmitted and/or received during a time interval in a predetermined way. Beam measurement refers to the operation of the TRP(s) and/or the UE to measure characteristics of received beamformed signals. Beam reporting refers to the operation of the UE reporting information of beamformed signal(s) based on beam measurement.

Beam determination refers to the operation of TRP(s) or UE selecting of its own Tx/Rx beam(s). Beam maintenance refers to the operation of TRP(s) or UE maintaining the candidate beams by beam tracking or refinement to adapt to the channel changes due to UE movement or blockage. Beam recovery refers to the operation of the UE identifying new candidate beam(s) after detecting beam failure and subsequently inform TRP of beam recovery request with information of indicating the new candidate beam(s).

Regarding UL beam-management in NR, according to 3GPP technical specification (TS 38.214), two transmission schemes, codebook-based transmissions and non-codebook based transmissions, are supported for the physical uplink shared channel (PUSCH). For PUSCH transmission(s) dynamically scheduled by an UL grant in a downlink control information (DCI), a UE shall upon detection of a physical downlink control channel (PDCCH) with a configured DCI format 0_0 or 0_1 transmit the corresponding PUSCH as indicated by that DCI.

For PUSCH scheduled by DCI format 0_0 on a cell, the UE shall transmit PUSCH according to the spatial relation, if applicable, corresponding to the physical uplink control channel (PUCCH) resource with the lowest identity (ID) within the active UL bandwidth part (BWP) of the cell, and the PUSCH transmission is based on a single antenna port. A spatial setting for a PUCCH transmission is provided by higher layer parameter PUCCH-SpatialRelationInfo if the UE is configured with a single value for higher layer parameter pucch-SpatialRelationInfoId; otherwise, if the UE is provided multiple values for higher layer parameter PUCCH-SpatialRelationInfo, the UE determines a spatial setting for the PUCCH transmission based on a received PUCCH spatial relation activation/deactivation MAC control element (CE) as described in 3GPP TS 38.321. The UE applies a corresponding setting for a spatial domain filter to transmit PUCCH 3 msec after the slot where the UE transmits hybrid automatic repeat request acknowledgement (HARQ-ACK) information with ACK value corresponding to a PDSCH reception providing the PUCCH-SpatialRelationInfo. As used herein, “HARQ-ACK” may represent collectively the positive acknowledge (ACK) and the negative acknowledge (NACK). ACK means that a transport block (TB) is correctly received while NACK means the TB is erroneously received.

For codebook-based transmission, PUSCH can be scheduled by DCI format 0_0 or DCI format 0_1. If a PUSCH is scheduled by DCI format 0_1, the UE determines its PUSCH transmission precoder based on Sounding Reference Signal Resource Indicator (SRI), Transmit Precoding Matrix Indicator (TPMI) and the transmission rank from the DCI, given by DCI fields of Sounding Reference Signal (SRS) resource indicator and Precoding information and number of layers (e.g., as defined in subclause 7.3.1.1.2 of 3GPP TS 38.212). The TPMI is used to indicate the precoder to be applied over the antenna ports {0 . . . v−1} and that corresponds to the SRS resource selected by the SRI (unless a single SRS resource is configured for a single SRS-ResourceSet set to ‘codebook’).

The transmission precoder is selected from the uplink codebook that has a number of antenna ports equal to higher layer parameter nrofSRS-Ports in SRS-Config, e.g., as defined in Subclause 6.3.1.5 of 3GPP TS 38.211. When the UE is configured with the higher layer parameter txConfig set to ‘codebook,’ the UE is configured with at least one SRS resource. The indicated SRI in slot n is associated with the most recent transmission of SRS resource identified by the SRI, where the SRS resource is prior to the PDCCH carrying the SRI before slot n.

The UE determines its codebook subsets based on TPMI and upon the reception of higher layer parameter codebookSubset in PUSCH-Config which may be configured with values ‘fullyAndPartialAndNonCoherent,’ or ‘partialAndNonCoherent,’ or ‘nonCoherent,’ depending on the UE capability. The maximum transmission rank may be configured by the higher parameter maxRank in PUSCH-Config.

For non-codebook based transmission, PUSCH can be scheduled by DCI format 0_0 or DCI format 0_1. The UE can determine its PUSCH precoder and transmission rank based on the wideband SRI when multiple SRS resources are configured in an SRS resource set with higher layer parameter usage in SRS-ResourceSet set to ‘nonCodebook,’ where the SRI is given by the SRS resource indicator in DCI format 0_1 (e.g., according to subclause 7.3.1.1.2 of 3GPP TS 38.212) and only one SRS port is configured for each SRS resource. The indicated SRI in slot n is associated with the most recent transmission of SRS resource(s) identified by the SRI, where the SRS transmission is prior to the PDCCH carrying the SRI before slot n.

The UE shall perform one-to-one mapping from the indicated SRI(s) to the indicated Demodulation Reference Signal (DM-RS) ports(s) given by DCI format 0_1 in increasing order.

In 3GPP NR Release 16 (Rel-16), for PUSCH scheduled by DCI format 0_0 on a cell and if the higher layer parameter enableDefaultBeamPlForPUSCH0_0 is set ‘enabled,’ the UE is not configured with PUCCH resources on the active UL BWP and the UE is in RRC connected mode, the UE shall transmit PUSCH according to the spatial relation, if applicable, with a reference to the reference signal (RS) with ‘QCL-Type-D’ corresponding to the QCL assumption of the CORESET with the lowest identity (ID). For PUSCH scheduled by DCI format 0_0 on a cell and if the higher layer parameter enable DefaultBeamPlForPUSCH0_0 is set ‘enabled,’ the UE is configured with PUCCH resources on the active UL BWP where all the PUCCH resource(s) are not configured with any spatial relation and the UE is in RRC connected mode, the UE shall transmit PUSCH according to the spatial relation, if applicable, with a reference to the RS with ‘QCL-Type-D’ corresponding to the QCL assumption of the CORESET with the lowest ID in case CORESET(s) are configured on the component carrier (CC).

According to 3GPP Rel-16 TS 38.214, Rel-16 NR supports a MAC CE based spatial relation update for aperiodic SRS per resource level and a default UL beam for an SRS resource for latency and overhead reduction in UL beam management.

Regarding DL beam-management in NR, one possibility to handling CSI reporting feedback for beam management is to use group-based beam reporting. However, due to no association with TRPs, the benefit is only limited to reduce overhead from feedback point of view and TRP-based beam management cannot benefit much. According to section 5.2.1.4 of 3GPP TS 38.214 (v16.0.0), following is specified in terms of CSI reporting:

If the UE is configured with an information element (IE) CSI-ReportConfig with the higher layer parameter reportQuantity set to ‘cri-RSRP’ or ‘ssb-Index-RSRP,’ then if the UE is configured with the higher layer parameter groupBasedBeamReporting set to ‘disabled,’ the UE is not required to update measurements for more than 64 CSI-RS and/or SSB resources, and the UE shall report (e.g., in a single report) the parameter nrofReportedRS (higher layer configured) different CRI or SSBRI for each report setting. However, if the UE is configured with the higher layer parameter groupBasedBeamReporting set to ‘enabled,’ the UE is not required to update measurements for more than 64 CSI-RS and/or SSB resources, and the UE shall report in a single reporting instance two different CRI or SSBRI for each report setting, where CSI-RS and/or SSB resources can be received simultaneously by the UE either with a single spatial domain receive filter, or with multiple simultaneous spatial domain receive filters.

If the UE is configured with the IE CSI-ReportConfig with the higher layer parameter reportQuantity set to ‘cri-SINR’ or ‘ssb-Index-SINR,’ then if the UE is configured with the higher layer parameter groupBasedBeamReporting set to ‘disabled,’ the UE shall report (i.e., in a single report) nrofReportedRSForSINR (higher layer configured) different CRI or SSBRI for each report setting. However, if the UE is configured with the higher layer parameter groupBasedBeamReporting set to ‘enabled,’ the UE shall report in a single reporting instance two different CRI or SSBRI for each report setting, (i.e., where CSI-RS and/or SSB resources can be received simultaneously by the UE either with a single spatial domain receive filter, or with multiple simultaneous spatial domain receive filters).

In the context of wireless communications and beamforming, the term quasi-co-location (QCL) refers to a relation of two beams or antenna elements that exhibit very similar or nearly identical physical characteristics and propagation properties, even though they might not be exactly co-located. These characteristics include (but are not limited to) properties such as: direction of transmission or reception (e.g., both beams are directed towards the same or nearly the same area or user); path loss (e.g., the attenuation of signal strength over the distance between the transmitter and receiver is very similar for both beams); delay spread (e.g., both beams experience similar delays due to multipath propagation effects, resulting in close temporal characteristics); and doppler shift (e.g., the relative velocity between the transmitter, receiver, and any moving objects is similar, leading to comparable frequency shifts).

The term “quasi” is used because the beams are not exactly co-located since they are not necessarily coming from the exact same point. However, because the propagation conditions and transmission paths are almost identical, the beams can be treated (i.e., assumed) as if they were coming from the same source in some respects, thereby simplifying the signal processing and improving communication efficiency.

Regarding QCL assumptions, according to current 3GPP specification, there is only one QCL type, i.e., qcl-typeD for spatial relation between the source RS and target RS. This means that only a single source to single target beam association can be established. However, as we go higher in frequency, the number of beams could become a lot higher, therefore, more coarse association could be considered to cover wider areas. Also, from transmission configuration indicator (TCI) indication point of view, there was enhancement in Rel. 16 to indicate up to two TCI states corresponding to two TRPs. However, this is still quite limited when there could be possibly a higher number of TRPs for Frequency Range #2 (FR2), i.e., frequencies from 24.25 GHz to 52.6 GHz, and beyond. According to section 5.1.5 of 3GPP TS 38.214 (v16.0.0), following is specified in terms of QCL assumptions:

The UE can be configured with a list of up to M TCI-State configurations within the higher layer parameter PDSCH-Config to decode PDSCH according to a detected PDCCH with DCI intended for the UE and the given serving cell, where M depends on the UE capability parameter maxNumberConfiguredTCIstatesPerCC. Each TCI-State contains parameters for configuring a QCL relationship between one or two downlink reference signals and the DM-RS ports of the PDSCH, the DM-RS port of PDCCH or the CSI-RS port(s) of a CSI-RS resource.

The QCL relationship is configured by the higher layer parameter qcl-Type1 for the first DL RS, and higher layer parameter qcl-Type2 for the second DL RS (if configured). For the case of two DL RSs, the QCL types shall not be the same, regardless of whether the references are to the same DL RS or different DL RSs. The QCL types corresponding to each DL RS are given by the higher layer parameter qcl-Type in QCL-Info and may take one of the following values: 1) ‘QCL-TypeA’: {Doppler shift, Doppler spread, average delay, delay spread}; 2) ‘QCL-TypeB’: {Doppler shift, Doppler spread}; 3) ‘QCL-TypeC’: {Doppler shift, average delay}; 4) ‘QCL-TypeD’: {Spatial Rx parameter}.

In certain embodiments, the UE receives an activation command (e.g., as described in clause 6.1.3.14 of 3GPP TS 38.321) used to map up to 8 TCI states to the codepoints of the DCI field ‘Transmission Configuration Indication’ in one CC/DL BWP or in a set of CCs/DL BWPs, respectively. When a set of TCI state IDs are activated for a set of CCs/DL BWPs, where the applicable list of CCs is determined by indicated CC in the activation command, the same set of TCI state IDs are applied for all DL BWPs in the indicated CCs.

When a UE supports two TCI states in a codepoint of the DCI field ‘Transmission Configuration Indication’ the UE may receive an activation command (e.g., as described in clause of 3GPP TS 38.321), the activation command being used to map up to 8 combinations of one or two TCI states to the codepoints of the DCI field ‘Transmission Configuration Indication.’ The UE is not expected to receive more than 8 TCI states in the activation command.

When the UE would transmit a PUCCH with HARQ-ACK information in slot n corresponding to the PDSCH carrying the activation command, the indicated mapping between TCI states and codepoints of the DCI field ‘Transmission Configuration Indication’ should be applied starting from the first slot that is after slot

$$n + 3 {N}_{slot}^{subframe , μ}$$

where μ is the subcarrier spacing (SCS) configuration for the PUCCH.

If parameter tci-PresentInDCI is set to “enabled” or if parameter tci-PresentInDCI-ForFormat1_2 is configured for the CORESET scheduling the PDSCH, and the time offset between the reception of the DL DCI and the corresponding PDSCH is equal to or greater than timeDurationForQCL if applicable, after a UE receives an initial higher layer configuration of TCI states and before reception of the activation command, the UE may assume that the DM-RS ports of PDSCH of a serving cell are quasi co-located with the synchronization signal/physical broadcast channel (SS/PBCH) block determined in the initial access procedure with respect to ‘QCL-TypeA,’ and when applicable, also with respect to ‘QCL-TypeD.’

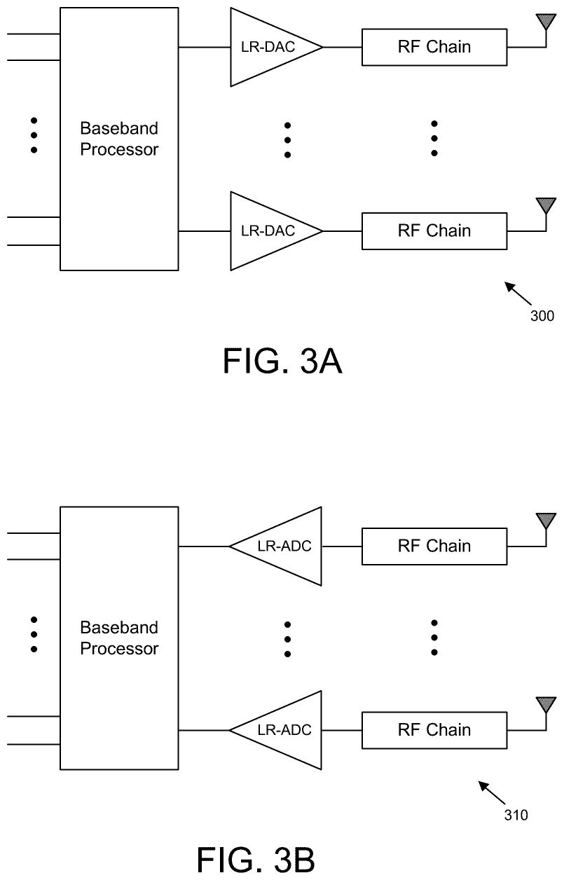

Different examples of MIMO architectures of array Tx/Rx beamforming with LR radios are depicted in FIGS. 3A-3B, 4A-4B and 5A-5B depict.

FIG. 3A illustrates an example of a MIMO architecture 300 with an LR radio array in accordance with aspects of the present disclosure. In the example of FIG. 3A, the MIMO architecture 300 may comprise an LR transmission (Tx) radio array comprising a baseband processor (e.g., combiner) which produces a plurality of radio frequency (RF) outputs, each RF output sent to a respective RF chain via an LR-DAC.

FIG. 3B illustrates another example of a MIMO architecture 310 with an LR radio array in accordance with aspects of the present disclosure. In the example of FIG. 3B, the MIMO architecture 310 may comprise an LR reception (Rx) radio array comprising a plurality of antennas connected to a plurality of radio chains which produce a plurality of RF inputs corresponding to a received MIMO signal, each RF input sent to a baseband processor (e.g., combiner) a respective LR-ADC.

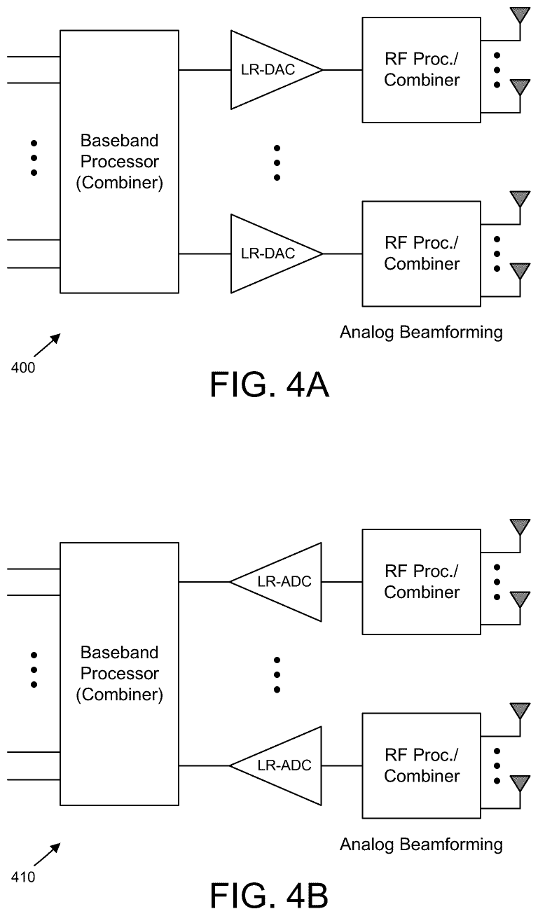

FIG. 4A illustrates an example of a MIMO architecture 400 with an LR radio array with analog beamforming in accordance with aspects of the present disclosure. In the example of FIG. 4A, the MIMO architecture 400 may comprise an LR Tx radio array with analog beamforming. Here, the baseband processor (e.g., combiner) produces a plurality of RF outputs, each RF output sent to a respective RF processor/combiner via an LR-DAC, where each RF processor/combiner transmits the RF signal using a set of antenna elements. It can be observed that, due to the LR status of the Tx radio chains (and thereby the introduced quantization distortion), a radio chain associated with an analog array beamforming will suffer from the quantization distortion added to the quantized Tx signal, which lead to different (degraded) beam measurement quality.

FIG. 4B illustrates another example of a MIMO architecture 410 with an LR radio array with analog beamforming in accordance with aspects of the present disclosure. In the example of FIG. 4B, the MIMO architecture 410 may comprise an LR Rx radio array with analog beamforming. Here, the LR Rx radio array comprises a plurality of antennas connected to a plurality of RF processors/combiners which produce a plurality of RF inputs corresponding to a received MIMO signal, each RF input sent to a baseband processor (e.g., combiner) a respective LR-ADC. It can be observed that, due to the LR status of the Rx radio chains (and thereby the introduced quantization distortion), a radio chain associated with an analog array beamforming will suffer from the quantization distortion added to the quantized Rx signal, which lead to different (degraded) beam measurement quality.

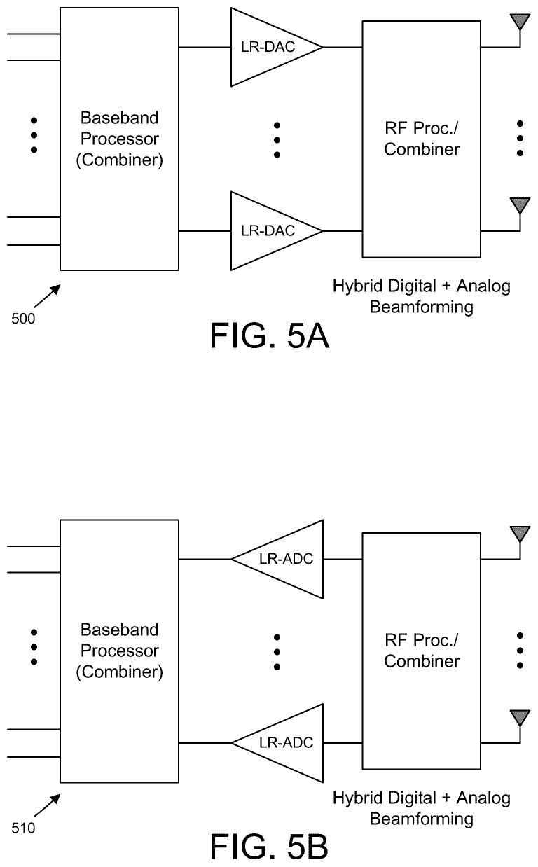

FIG. 5A illustrates an example of a MIMO architecture 500 with an LR radio array with hybrid digital and analog beamforming in accordance with aspects of the present disclosure. In the example of FIG. 5A, the MIMO architecture 500 may comprise an LR Tx radio array with hybrid digital and analog beamforming. Here, the baseband processor (e.g., combiner) produces a plurality of RF outputs sent via an LR-DAC to a hybrid digital and analog beamforming block, where the hybrid digital and analog beamforming block transmits the RF signal using a set of antenna elements. It can be observed that, due to the LR status of the Tx radio chains (and thereby the introduced quantization distortion), a Tx beam associated with an array of LR radio chains (via a digital Tx beamforming) may suffer from degraded spatial signature due to the reduced beam quality (increased sidelobe or degraded beamwidth/alignment).

FIG. 5B illustrates another example of a MIMO architecture 510 with an LR radio array with hybrid digital and analog beamforming in accordance with aspects of the present disclosure. In the example of FIG. 5B, the MIMO architecture 510 may comprise an LR Rx radio array with hybrid digital and analog beamforming. Here, the LR Rx radio array comprises a plurality of antennas connected to a hybrid digital and analog beamforming block, where the hybrid digital and analog beamforming block produces a plurality of RF inputs corresponding to a received MIMO signal, each RF input sent to a baseband processor (e.g., combiner) a respective LR-ADC.

In the above-described LR conditions for MIMO architecture, in general, and in some particular cases when the LR chains are utilized interchangeably with the HR beams, it is of interest to determine a beam with the LR status for the purpose of the transmission and reception, considering the potential benefits and down-sides of the LR operation.

Given at least one LR beam transmitted by the first radio node and received by the second radio node among a plurality of transmissions of the HR beams and/or LR beams by the first radio node received by the second radio node, the present disclosure describes techniques to realize the awareness at the first radio node of whether the second radio node is served by an LR SSB beam or by an HR SSB beam. In some aspects, the first radio node gains this awareness during the initial access procedure using separate SSB-RACH associations for the LR SSB beam and the HR SSB beam.

In some aspects of the present disclosure, the second radio node determines that a received transmission (e.g., SSB transmission) is associated with the LR transmit condition (also referred to as “LR status”) of the first radio node by receiving an explicit or implicit indication of the LR status of the transmission by the first radio node and according to a criterion (self-determined or configured/pre-configured) for determining an LR transmission among the plurality of transmission having the LR status and/or HR status. In other words, the second radio node selects an LR transmission based on criteria specific to selection of an LR transmit condition.

In some aspects of the present disclosure, the second radio node selects an Rx beam corresponding to the transmission of the LR beam by the first radio node, e.g., according to an indicated association between the LR Tx beam with an HR beam of the first radio node. In certain embodiments, the indicated association includes a description of the LR beam, e.g., in relation to the HR beam. For example, the indicated association may be a QCL association between the LR beam and the HR beam, and the description may define and/or describe the LR beam in relation to a known HR beam. In various aspects, the second radio node selects the Rx beam for generating a measurement report, or for reception of a physical channel.

In some aspects of the present disclosure, the second radio node performs selection of an Rx beam corresponding to the transmission by the HR beam of the first radio node, according to an indicated association between the HR Tx beam with an LR beam of the first radio node, wherein the association includes description of the HR beam in relation to the LR beam. For example, the indicated association may be a QCL association between the LR beam and the HR beam, and the description may define/describe the HR beam in relation to a known LR beam. In various aspects, the second radio node selects the Rx beam for generating a measurement report, or for reception of a physical channel.

Note that the present disclosure is not limited to any single embodiment and/or implementation elements individually, and one or more elements from one or more implementations and/or embodiments may be combined to construct a new embodiment.

According to aspects of a first solution, a first radio node may be configured to transmit with one or more LR beams and one or more HR beams. Note that various aspects of the solutions described in the present disclosure may be combined to construct a new solution. In some embodiments, the LR status of a beam or transmission may be associated with (at least in part) one or more of the following features: 1) A Tx/Rx beam associated with a radio chain with LR DAC/ADC (e.g., an LR beam is generated via analog phase rotation of an LR DAC output into an array of antennas); 2) A Tx/Rx beam associated with an array of radio chains with low-resolution DAC/ADC (e.g., an array digital beamforming of multiple radio chains with LR conversion ADC/DAC); 3) A Tx/Rx beam associated with a radio chain with a reduced maximum achievable signal-to-noise ratio (SNR) (or signal-to-interference-plus-noise ratio (SINR)) limited by the transmission or reception quantization (DAC/ADC distortion), achievable/supported error vector magnitude (EVM) due to the quantization distortion, achievable throughput or spectral efficiency (supported rate per time unit and/or frequency unit); 4) A Tx/Rx beam associated with a radio chain with a reduced Tx/Rx power consumption (e.g., a higher energy efficiency beam for an equal level of desired transmission power); 5) A Tx/Rx beam associated with a limited/specific/pre-defined set of supported modulation and coding scheme; 6) A Tx/Rx beam associated with a limited/specific/pre-defined set of supported waveform type and/or waveform parameters; or combinations thereof.

In some embodiments, the LR status of a beam or transmission may be defined/interpreted as stand-alone features (e.g., a transmission via a radio chain with maximum of 6 DAC bits would be interpreted with an LR status). In some other embodiments, the LR and/or HR status of a beam is defined/interpreted in relation to the assumed features of the other (HR and/or LR) beam/transmission status, e.g., the LR transmission status may be associated with a transmission with X dB smaller maximum achievable Tx SNR compared to a beam/transmission of HR status, or a quantization with a B bits less resolution.

In some embodiments, a plurality of LR types may be supported and the type of the LR status can be indicated and/or defined via an index from a codebook, where the codebook includes different possible combinations of the above features. For example, one such index from the codebook may define a max SNR value. As another example, one such index from the codebook may define an energy efficiency/consumption index. In further examples, indices from the codebook may indicate supported modulation and coding schemes (MCS), the number of quantization bits, etc.

In some embodiments, the LR status of a radio chain and/or beam may be associated with supported number of quantization DAC/ADC states or bits being above/below a threshold. For example, a DAC with less than 7 quantization bits and ADC with less than 8 quantization bits may be referred to as an LR DAC/ADC and a radio chain equipped with an LR DAC/ADC may be referred to as an LR radio chain.

In some embodiments, the LR status of a radio chain and/or beam may be associated with a required level of the supported error vector magnitude (EVM) or the, e.g., maximum achievable Tx SNR or Rx SNR (i.e., associated with the ADC or DAC distortion), or the modulation error ratio (MER) at the Tx or Rx due to the impact of quantization distortion. In one example, a Tx/Rx chain with (maximum Rx) SNR or MER of less than 30 dB due to the impact of DAC/ADC quantization may be associated with an LR transmit condition. In another example, a Tx/Rx chain with (maximum Rx) SNR or MER of more than 30 dB due to the impact of DAC/ADC quantization may be associated with an HR transmit condition.

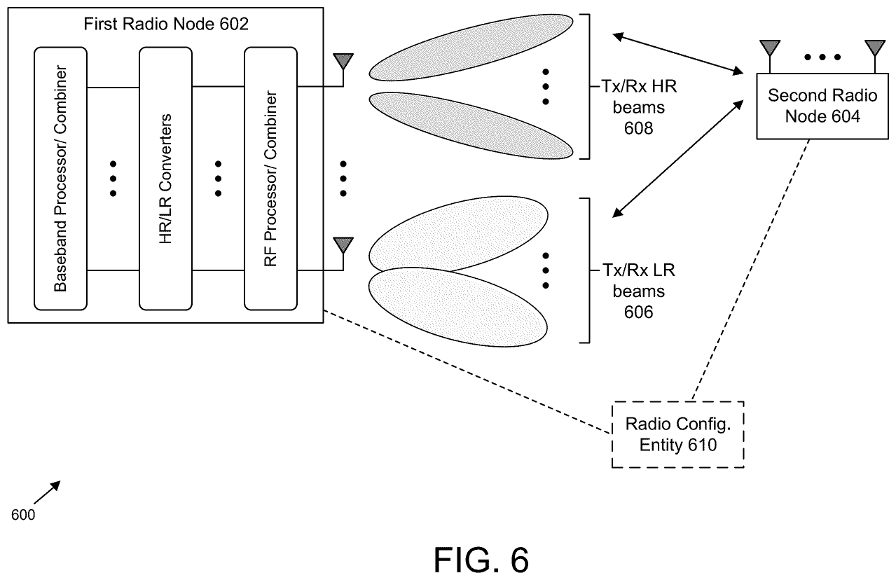

FIG. 6 illustrates an example of a communication scenario 600 between a first radio node 602 and a second radio node 604 in accordance with aspects of the present disclosure. The first radio node 602 may communicate via a set of one or more LR beams 606 and/or with a set of one or more HR beams 608. In certain embodiments, a radio configuration entity 610 may configure radio behavior of the first radio node 602 and the second radio node 604. In certain embodiments, the radio configuration entity 610 may be co-located with the first radio node 602, or the second radio node 604, or both.

In some embodiments, the first radio node 602 is a gNB. In such embodiments, the LR transmissions and/or HR transmissions are associated with DL RS beams, e.g., DL SSB, sidelink (SL) CSI-RS, DL-PRS, and the like.

In some implementations of the communication scenario 600, the first radio node 602 is a RAN node (e.g., gNB) and the second radio node 604 is a UE, wherein the radio configuration entity 610 is co-located at the first radio node 602 (e.g., for configuring DL transmission via an LR gNB Tx beam).

In some implementations of the communication scenario 600, the first radio node 602 is a UE and the second radio node 604 is a RAN node (e.g., gNB), wherein the radio configuration entity 610 is co-located at the second radio node 604 (e.g., for configuring UL transmission via a Tx LR UE beam).

In some implementations of the communication scenario 600, the first radio node 602 is a first UE and the second radio node 604 is a second (different) UE. In such implementations, the radio configuration entity 610 may be co-located at the second radio node 604, at the first radio node 602, or at a third node (e.g., at a gNB associated with the first and/or second UE). For example, the radio configuration entity 610 may configure SL transmission via a Tx LR UE beam.

In some implementations of the communication scenario 600, the first radio node 602 is a first TRP (or gNB or RAN node) and the second radio node 604 is a second TRP (or gNB or RAN node), wherein the radio configuration entity 610 is co-located at the first radio node 602 or the second radio node 604, or at a third entity, such as a location or sensing management function residing in RAN or at the core network, location management function (LMF) or sensing function (SF) residing at the core or RAN. For example, the radio configuration entity 610 may configure a sensing measurement via TRP-TRP transmission of an LR Tx beam of the first radio node 602 and reception/measurement of the second radio node 604.

In some embodiments, the LR status of the Tx beams of the first radio node 602 are transparent to the second radio node 604. In some embodiments the second radio node 604 is not required to determine the LR status of the Tx beams of the first radio node 602. In some embodiments, the second radio node 604 may obtain explicit or implicit indication of the Tx LR beam status, such as upon request or upon decoding of a message containing the information. For example, the UE may decode a known field of a SIB upon interest containing information on the LR Tx beam status.

In some embodiments, the LR status of the of the Tx beams of the first radio node 602 is explicitly indicated to the second radio node 604, for instance via information embedded within the payload of a physical DL/UL/SL data or control channel. For example, a gNB may explicitly indicate the LR status via a dedicated field of a message sent via broadcast signaling to the second radio node 604, or via a DCI with cyclic redundancy check (CRC) scrambled via a group common (GC) radio network temporary identifier (RNTI) or a dedicated RNTI.

In other embodiments, the LR status of the of the Tx beams of the first radio node 602 is indicated to the second radio node implicitly. For example, the first radio node 602 may implicitly indicate the LR status via an indicated condition of a transmission of a signal according to which the second radio node 604 may infer the LR status of the transmission beam. In one instance, an absolute or relative time-frequency resource position may be associated with transmission beam with LR status, such that the second radio node 604 may assume a configured signal (e.g., an RS) occupying at least in part the indicated resource to be associated with the LR transmission status.

As another example, the first radio node 602 may implicitly indicate the LR status via a sequence type associated with the LR status of the Tx beam, with the sequence embedded within an RS received by the second radio node 604, such as a DMRS of a physical channel transmitted via the LR beam and received by the second radio node 604, or a CSI-RS transmitted via the LR beam and received by the second radio node 604, or a PSS/SSS transmitted via the LR beam, or combinations thereof.

In yet another example, the first radio node 602 may implicitly indicate the LR status via an indication of an association of a first transmission/beam with a second transmission/beam of an LR status, wherein the second transmission is known by the second radio node 604 to be associated with an LR status. Responsive to receiving the indication of the association, the second radio node 604 may assume the first transmission/beam is associated with the LR status. Note that combinations of the foregoing implicit indications are possible.

According to aspects of a second solution, the first radio node (e.g., a gNB) may become aware of whether the second radio node (e.g., a UE) is served by LR or HR SSB beam using SSB-RACH occasion association. Note that various aspects of the solutions described in the present disclosure may be combined to construct a new solution. In certain embodiments the LR beam status may be transparent to the second radio node (e.g., UE) and the LR beam status does not require any specific behavior of the second radio node.

In some embodiments, when the second radio node is configured with the reception of a transmission (an RS, a SSB, a physical data/control channel) such that the LR beam status of the transmission is known to (or determinable by) the second radio node, the second radio node behavior is not impacted by the LR transmission status. For example, upon receiving SS/PBCH on a set of SSB beams and/or SSB occasions associated with the LR beam status, and upon detection and selection/determination of a best SSB beam, the second radio node determines the random access channel (RACH) occasion (RO) corresponding to the selected/determined SSB. As such, upon receiving a physical random access channel (PRACH) transmission on the corresponding RO, the first radio node (e.g., network/gNB) may identify, based on the RO, the SSB beam selected/determined by the second radio node, and thus identify (i.e., become aware of) the associated LR beam status. For example, the set of SSB beams associated with the LR beam status may be associated with a PRACH configuration that is different than the PRACH configuration of the set of SSB beams associated with the HR beam status. A respective PRACH configuration may indicate one or more of: the PRACH preambles to be used, a pattern of valid ROs, a number of SSB per RO, a number of PRACH preambles per SSB, the number of PRACH transmission opportunities within a slot and/or subframe, or frequency resources to be used for the PRACH transmission. By associating the LR SSB beams with different PRACH configurations than the HR SSB beams, the differing characteristics of the different PRACH configurations can be used to identify whether the SSB beam selected/determined by the second radio node is an LR beam or an HR beam. Beneficially, this technique does not require any specific indication from the UE regarding the LR beam status of the SSB beam. Moreover, this technique does not require knowledge of the LR beam status by the UE that receives the SSB beam.

In some embodiments, the SSB transmission of the first radio node (e.g., gNB) include at least a first set of SS/PBCH transmissions associated with an LR beam and a second set of SS/PBCH transmission associated with an HR beam. While the notation “first set” and “second set” is used to distinguish the LR/HR beam status associated with the SS/PBCH transmissions, the terms “first” and “second” do not require any temporal or causal relation between the sets. For example, the first set may be transmitted concurrently with the second set. As another example, the first set may be transmitted subsequent to the second set, e.g., once certain conditions are satisfied.

In some embodiments, the transmission of the first set of LR SS/PBCH transmissions and the transmission of the second set of HR SS/PBCH transmissions are associated with separate sets of RACH transmission configurations. Such association may map specific SSB beams and/or SSB transmission occasions with time-frequency resources for RACH transmission. In such embodiments, the first radio node may determine the SSB beam detected/selected by the second radio node and the associated LR/HR beam status of the detected/selected SSB beam at least in part based on receiving a RACH transmission from the second radio node and the configured association of the SS/PBCH transmission beam/occasion and the RACH transmission.

In certain embodiments, the first set of SS/PBCH transmissions with LR beam status and the second set of the SS/PBCH transmissions with HR beam status, are associated with different RACH transmission configurations separated at different time and/or frequency occasions and/or different sequence types. In one embodiment, time-frequency resources for RACH transmission may be time domain multiplexed (TDMed) such that certain ROs are associated with beams having LR status, while other ROs are associated with beams having HR status. In another embodiment, time-frequency resources for RACH transmission may be frequency domain multiplexed (FDMed) such that certain frequency ranges are associated with beams having LR status, while other frequency ranges are associated with beams having HR status. In yet other embodiments, different combinations of time domain and frequency domain resources may be used to differentiate between beams having LR status and beams having HR status.

In certain embodiments, where a set of sequences (e.g., defined by one or more of length, root sequence number, and time/frequency shift) are associated with a shared RACH time/frequency occasion, the second radio nodes receiving the set of the SS/PBCH transmissions with LR status may be differentiated from the second radio nodes receiving the set of the SS/PBCH transmissions with HR status in the applicable sequence IDs to be used for the shared RACH occasion (i.e., between the LR and HR SSB transmissions).

In certain embodiments, a first set of root sequences numbers (and/or sequence ID and/or time/frequency shift) are assigned to the RACH transmissions associated with the first set of SS/PBCH transmissions with LR beam status and a second set of root sequences numbers (and/or sequence ID and/or time/frequency shift) are assigned to the RACH transmissions associated with the second set of SS/PBCH transmissions with HR beam status. In such embodiments, a respective second radio node receiving the SSB beam(s) having LR or HR status is not explicitly and/or implicitly informed of the HR/LR status of the received/detected SSB beam(s). However, the first radio node (e.g., gNB) determines the HR/LR status of the received/detected SSB via the received RACH transmission and the defined association of the PRACH transmission to the SSB beams. In some such embodiments, the separation of the root sequences numbers (and/or sequence ID and/or time/frequency shift) indicates to the first radio node whether the received/detected SSB has LR status or HR status.

In some embodiments, the second radio node may be aware (implicitly or explicitly indicated) of the LR or HR status of the beam. In such embodiments, the association of the Tx SSB to an LR status may be indicated, implicitly or explicitly, to a second radio node (e.g., UE) detecting the LR SS/PBCH transmissions. In other embodiments, the second radio node may not be aware of the LR or HR status of the received beams. Note that the LR/HR-aware behavior of the second radio node and/or the associated parameters for LR/HR-aware behavior may be autonomously determined, self-configure, pre-configured, configured by the configuration entity (or first radio node), or some combination thereof.

In some embodiments, when the second radio node (e.g., UE) is aware of the LR or HR status of the received beam, then the second radio node may perform certain actions based at least in part on the LR status of one or more transmissions. For example, the second radio node may receive configuration information (e.g., from the first radio node and/or the radio configuration entity) to allow the second radio node to differentiate between beams with LR status and beam with HR status. In some implementations, the behavior by the second radio node may include selection of a transmission/beam among the plurality of the transmissions made by the first radio node. For example, the second radio node may select an SSB and the associated PRACH occasion based on the performed DL measurements, and subsequently select a transmission occasion containing an RS (e.g., a CSI-RS) for the purpose of beam selection.

In certain embodiments, the second radio node may generate and transmit/report a reporting quantity based on measurement of the configured transmissions of the first radio node. As an example, the second radio node, upon knowledge of the LR status of one or more LR Tx beams of the first radio node, may report an L1 measurement of at least one of the Tx beams associated with the LR beam status. Moreover, to reduce energy consumption of the network, the second radio node may preferentially select a beam with LR status (e.g., for generating a measurement report on the beam, or for recommending the beam to be used for DL physical channel transmission, or for indicating the beam as a detected SSB). In other words, the second radio node may first search among the available beams with LR status and only search among available beams with HR status if a selection condition is not satisfied by the available LR beams. Alternatively, the second radio node may use a lower reporting threshold for the LR beams, i.e., to prioritize the selection of an LR beam.

In certain embodiments, to improve link reliability (e.g., by achieving a higher SNR), the second radio node may preferentially select a beam with HR status (e.g., for generating a measurement report on the beam, or for recommending the beam to be used for DL physical channel transmission, or for indicating the beam as a detected SSB). As such, the second radio node may first search among the available beams with HR status and only search among available beams with LR status if a selection condition is not satisfied by the available HR beams. Alternatively, the second radio node may use a lower reporting threshold for the HR beams, i.e., to prioritize the selection of an HR beam.

As another example, when the second radio node is configured with reporting CSI measurements according to an indicated threshold on the measured value (e.g., reference signal received power (RSRP), or reference signal received power per-path (RSRPP) of a described path, etc.), then the second radio node, upon knowledge of the LR status of one or more LR Tx beams of the first radio node, assumes a different threshold for transmitting a measurement report associated with LR Tx beams. In one embodiment, the configuration information indicates a second threshold for beams having LR status. In certain embodiments, the second threshold is not explicitly defined for the second radio node; rather, the second threshold may be assumed/calculated based on the first threshold value (i.e., for beams having HR status) and knowledge of the LR status of the measured LR Tx beams. For example, without explicit indication of the new threshold, the second radio node may assume/calculate the second threshold for beams having LR status as being X % of the first threshold, where X is pre-configured.

In some embodiments, upon knowledge of the LR status of the one or more transmission beams of the first radio node, the second radio node behavior is determined (at least in part) based on an LR-specific configuration for one or more of reception, measurement (and reporting), or selection of an LR beam transmitted by the first radio node.

In some embodiments, the LR-specific configuration includes selecting and/or reporting of beam measurements for min{X, Xₘᵢₙ} LR transmissions of the first radio node, where X is an indicated, configured or pre-configured quantity, and Xₘᵢₙ is the number of the Tx beams of the first radio node with LR status known to the second radio node, regardless of the obtained measurement value among all of the measurements. In other words, even if the measurements based on beams other than the known LR beams generate higher values, upon knowledge of the value X and the knowledge of the Xₘᵢₙ beans with LR status, the second radio node shall generate and report the min{X, Xₘᵢₙ} best measurements associated with LR status of the first radio node. In some such examples, the value of X is not indicated/defined and shall be interpreted as infinity, i.e., to generate report on all of the known LR transmissions of the first radio node.

In some embodiments, the LR-specific configuration includes selecting and/or reporting of the best one or multiple (i.e., indicated number) of beams, where the beams with LR status are sorted among all transmission/beams (i.e., combined HR and LR transmission/beams), and where the measurements of the transmissions/beams associated with LR status are benefited with an advantage of Δ_{LR} (i.e., where the value of Δ_{LR} is indicated, or configured, or defined, or pre-configured). As such, when the second radio node selects the N best beams/measurements (i.e., where the value of N is indicated, or configured, or defined, or pre-configured) among the plurality of the both HR and LR beams based on a measured quantity (e.g., measured RSRP or received signal strength indicator (RSSI)), the sorting of the beams/measurements to determine the best N measurements may be performed with favoring the measurements associated with the LR transmit condition with the value of Δ_{LR}. For example, an LR beam corresponding to an RSRP/RSSI measurement higher than C−Δ_{LR} would be deemed as superior compared to the measurement with value of C from a non-LR beam.

In some implementations, upon indication of the LR status of a transmission beam of the first radio node (e.g., with the LR beam associated with an SSB transmission or a CSI-RS transmission by the first radio node), the second radio node may perform a selection, e.g., based on the knowledge of the beam having LR status and the features/properties associated with the LR status (e.g., when the LR beam is not the best beam with respect to the CSI measurement metrics but is chosen or reported by the second radio node with the motivation of consuming less energy for a required DL traffic/throughput). Such selection may include the selection of a beam and/or the corresponding transmission occasion to be utilized to determine the PRACH transmission occasion/resource. Such selection may also include the selection of a beam for determining the DL PDSCH transmission. Beneficially, the selection of an LR beam may reduce energy and/or cost by the network, or the UE, or both.

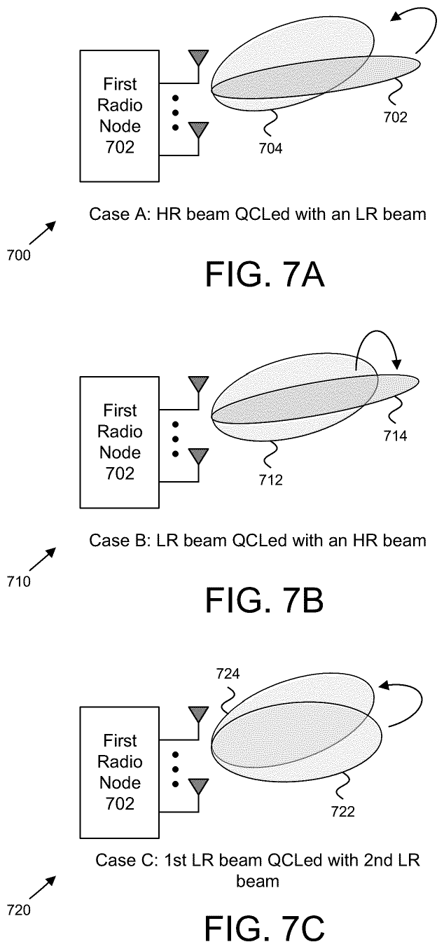

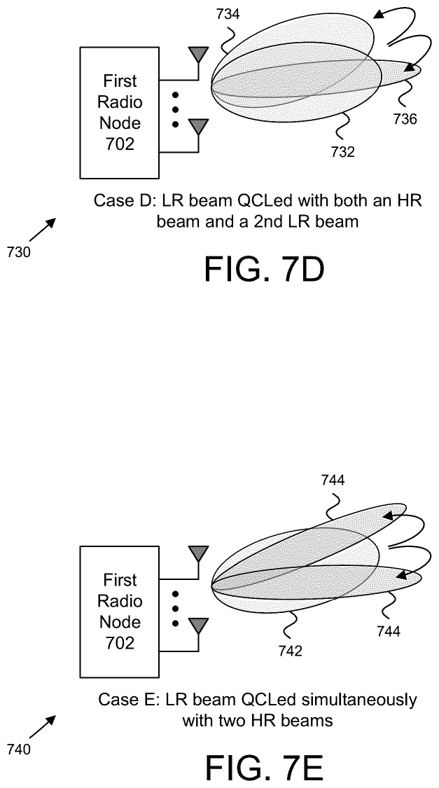

The present disclosure considers various relations between two beams including at least a beam with an LR status which may be indicated to the second radio node (e.g., from the first radio node and/or the radio configuration entity), several of which are described below with reference to FIGS. 7A-7E. In some embodiments, the second radio node receives an indication that a Tx beam of the first radio node is associated with (i.e., related to) to a second Tx beam (or a multiple of the Tx beams) of the first radio node in one or a subset of its features (i.e., beam characteristics), where the Tx beams include at least one beam with an LR transmit condition. In some embodiments, the association is described as a QCL relation between two or more beams.

FIG. 7A illustrates an example of a QCL relation between two or more beams in accordance with aspects of the present disclosure. In the example of FIG. 7A, a first relation 700 between two beams is depicted (referred to as Case A). In the first relation 700, an HR beam 702 is QCLed with an LR beam 704. In some embodiments, the first relation 700 describe in Case A is defined (or interpreted) as the HR beam 702 having approximately the same spatial beam center direction or having the same ideal spatial pattern of the QCLed LR beam 704 In the latter scenario, the difference of the beams' spatial signatures is due to the impact of LR quantization/conversion technique, e.g., when an array of HR or LR chains are utilized to perform digital beamforming to generate HR or LR beams.

As used herein, the spatial center direction of a beam refers to the central axis or main direction in which the energy of the beam is concentrated and radiated in space. This is typically the direction where the beam has the highest intensity or gain, and it is often represented by the peak of the beam's radiation pattern. The radiation pattern of a beam usually has a main lobe, and the spatial center direction is the axis of this main lobe. Moreover, for Tx beams, the spatial center direction may also be referred to as the angle-of-departure (AOD), i.e., that angle at which the beam departs from the transmitter. For Rx beams, the spatial center direction may also be referred to as the angle-of-arrival (AOA), i.e., that angle from which the beam is capturing incoming signals. In a spherical coordinate system, the AoD and AoA may each have an elevation (i.e., vertical angle) component (typically represented as “θ”) and an azimuth (i.e., horizontal angle) component (typically represented as “Φ”).

In addition to the spatial center direction, a beam's spatial signature includes such characteristics as phase shift (i.e., the differences in phase experienced by the signal across different antennas or spatial paths, which arise due to the varying distances and propagation conditions of each path); amplitude profile (i.e., a signal's power distribution across different paths or antennas, reflecting how much signal power is received or transmitted in each direction); multipath components (e.g., the respective delays, directions, and signal strengths associated with different propagation paths); and Doppler shift (i.e., the frequency shift caused by relative motion between the transmitter, receiver, or reflecting objects, which can also be part of the spatial signature in dynamic environments). Fundamentally, the spatial signature characterizes how the wireless signal interacts with the environment in terms of direction, phase, and power across different antennas or paths.

In some embodiments, the first relation 700 is described (e.g., defined/interpreted) as the LR and HR beams sharing the same spatial pattern; however, the transmission of the LR beam 704 is performed via an LR radio chain impacted by the LR converters. In some such examples, the HR and LR beams are generated via analog beamforming of a radio chain associated (respectively) with the HR and LR transmit conditions. In some examples, a new QCL type is defined to describe the first relation 700 defined in Case A as above.

FIG. 7B illustrates another example of a QCL relation between two or more beams, in accordance with aspects of the present disclosure. In the example of FIG. 7B, a second relation 710 between two beams is depicted (referred to as Case B). In the second relation 710, an LR beam 712 is QCLed with an HR beam 714. In some examples, the spatial pattern of an HR beam is translated to an LR spatial pattern via a deterministic function, e.g., based on a known structure.

In some embodiments, the second relation 710 is the same (or reverse) as described via the examples of Case A. In some embodiments, the spatial signature of the LR beam 712 can be related/generated via a known relation to the HR beam 714. In one such example, the geometrical shape of the LR beam 712 from the azimuth angle can be generated via f_{LR}(θ, φ)=g(f_{HR}(θ, φ)) wherein the function g(.) is defined explicitly or implicitly to the indicated QCL type and/or the defined type of the beam behavior specific to the LR/HR status. In one example, the function g(.) corresponds to the reduction of the resolution of the beam-generating chains according to the described beam characteristics of the LR beam. In some examples, a new QCL type is defined to describe the second relation 710 defined in Case B.

FIG. 7C illustrates yet another example of a QCL relation between two or more beams, in accordance with aspects of the present disclosure. In the example of FIG. 7C a third relation 720 between two beams is depicted (referred to as Case C). In the third relation 720, a first LR beam 722 is QCLed with a second LR beam 724. In some examples, the defined relation informs of the first LR beam 722 being of the LR status, where the properties of the second LR beam 724 are previously known or separately defined.

In some examples, the third relation 720 further described the first LR beam 722 as being of the same type of the LR status as the second LR beam 724 (e.g., the first beam sharing the same or at least the same resolution and/or energy consumption properties of the second beam). In some examples, a new QCL type is defined to describe the third relation 720 defined in Case C.

FIG. 7D illustrates still another example of a QCL relation between two or more beams, in accordance with aspects of the present disclosure. In the example of FIG. 7D, a fourth relation 730 between multiple beams is depicted (referred to as Case D). In the fourth relation 730, a first LR beam 732 is QCLed with a second LR beam 734 and an HR beam 736. In some embodiments, the fourth relation 730 indicates the first beam 732 having an LR status, as associated with the second LR beam 734, and with the spatial characteristics of the first beam 732 being associated with the indicated HR beam 736.

In some examples, the spatial pattern of the first LR beam 732 is assumed according to the second LR beam 734, which is rotated to be aligned with the indicated HR beam 736, such that the 3D spatial pattern is taken from the second LR beam 734 and rotated such that the peak beam direction (i.e., beam spatial center direction) is aligned with the indicated HR beam. In some embodiments, a new QCL type is defined to describe the fourth relation 730 defined in Case D.

FIG. 7E illustrates a further example of a QCL relation between two or more beams, in accordance with aspects of the present disclosure. In the example of FIG. 7E, a fifth relation 740 between multiple beams is depicted (referred to as Case E). In the fifth relation 740, an LR beam 742 is QCLed with two or more HR beams 744 where the two or more HR beams 744 jointly describe the LR beam 742. In some embodiments, the spatial pattern of the LR beam 742 can be constructed via a linear combination of the two or more HR beams 744. In some examples, the QCL relation further indicates scalar weights for each of the two or more HR beams 744 to construct the LR beam 742. In one such example, the geometrical shape of the LR beam 742 from the azimuth angle can be

$${f}_{L R} ( θ , ϕ ) = {\sum }_{i} {α}_{i} {f}_{HR , i} ( θ , ϕ ) ,$$

wherein the constant alpha values (αᵢ) describe the strength of the sidelobes.

In some embodiments, if the second radio node is aware of the LR/HR status of a beam, the second radio node may utilize the knowledge of the LR beam characteristics (a priori or known), e.g., for Tx/Rx beam determination, for CSI estimation etc. For example, a beam relation to an LR beam via a QCL indication may be interpreted by the second radio node as described above.

In some embodiments, any of the above described configurations or indications (e.g., configuration/indication of the QCL relations, the LR status description of a beam, the measurement reporting of an LR beam, etc.) may be exchanged between the radio configuration entity and the first radio node or second radio node and/or between the first radio node and second radio node via the UL, DL or SL physical data and/or control channels defined within the communication network, e.g., NR physical broadcast channel (PBCH), PDSCH, PDCCH, PUSCH, PUCCH, physical sidelink broadcast channel (PSBCH), physical sidelink control channel (PSCCH), physical sidelink shared channel (PSSCH), via a higher layer (e.g., MAC control element (MAC-CE) or RRC) signaling.

According to aspects of a third solution, the first radio node transmits a set of beams at a first time-instance (e.g., first NR slots and/or subframes for which the first transmission is provisioned), where the transmitted set of beams are all associated with the same transmission status (i.e., HR status or LR status). Note that various aspects of the solutions described in the present disclosure may be combined to construct a new solution. In some embodiments, the transmitted set of beams is associated with all/any potential receivers (i.e., broadcast transmission). In some embodiments, the transmitted set of beams is associated with a set of (receiver) second radio nodes, i.e., a groupcast transmission or corresponding to a second radio node.

In some embodiments of the third solution, a subsequent transmission from the first radio node at a second time-instance (e.g., towards the same second radio node, same set of receivers, or same broadcast transmission condition), includes at least one or more beams with a different/modified status (HR/LR) compared to the first time-instance. In other words, in the first time-instance, the transmitted set of beams will have a homogenous HR/LR status, while in the second time-instance, one or more beams will transition to a different HR/LR status, e.g., responsive to a signal or indication from the second radio node(s). In some embodiments, the transmitted set of beams at the first time instance and the transmitted set of beams at the second time instance are similarly associated to the one or multiple or all receiver nodes (e.g., associated with the same second radio node as the receiver, or associated with a group cast transmission among the same set of receiver nodes or associated with a broadcast transmission).

In certain embodiments, the set of beams transmitted during the first time-instance includes beams with LR status and the set of beams transmitted during the second time-instance includes at least one beam associated with an HR status. In other embodiments, the transmission of the first time-instance includes beams with HR status and the transmission of the second time-instance includes at least one beam associated with an LR status.

In some embodiments, the determination by the first radio node (or the radio configuration entity) to switch the at least one beam from the LR status to the HR status (or vice versa) based, at least in part, on a feedback (e.g., explicit or implicit indication/recommendation for a modified HR or LR transmission status) and/or capability information received from the second radio node.

In some embodiments, the determination by the first radio node (or the radio configuration entity) to switch the at least one beam from the LR status to the HR status (or vice versa) based, at least in part, on a measurement report (e.g., RSRP, received signal strength/quality) by the one or more receiver nodes (i.e., second radio nodes) and/or on the measurement (by the first radio node) of the signal quality/strength of a received signal that was transmitted by the second radio node. In certain embodiments, the determination for transmission with a beam with an HR (in alternate embodiments, LR) is based, at least in part, on the transmission/measurement or measurement report based on a transmission with an LR status (in alternate embodiments, with HR status).

In one such example, the first radio node (or the radio configuration entity) determines to switch to using an LR beam status for transmission at the second time instance based on a measurement with a strength higher than a threshold of an HR beam transmitted by a second radio node. In another example, the first radio node (or the radio configuration entity) determines to switch to using an LR beam status for transmission at the second time instance based on a measurement report (received from the second radio node) indicating a received signal strength higher than a threshold (i.e., measuring an HR beam transmitted by the first radio node).

In one alternate example, the first radio node (or the radio configuration entity) determines to switch to using an HR beam status for transmission at the second time instance based on measurement with a strength lower than a threshold of an LR beam transmitted by a second radio node, or based on a measurement report (received from the second radio node) indicating a received signal strength lower than a threshold (i.e., measuring an LR beam transmitted by the first radio node).

In some embodiments, the set of beams transmitted during the first time-instance includes SS/PBCH transmission of a first one or more SSB, SSB burst, set of CSI-RS (or other RS, e.g., positioning reference signal (PRS), SRS, sensing RS, etc.), and the set of beams transmitted during the second time-instance includes SS/PBCH transmission of a second one or more SS/PBCH block, SS/PBCH burst/set, set of CSI-RS (or other RS).

In certain embodiments, the set of beams transmitted during the first time-instance includes a set of SS/PBCH transmissions transmitted with beams of HR status (in alternate embodiments, LR status) and the set of beams transmitted during the second time-instance includes a second set of SS/PBCH transmissions which are transmitted, at least partially, via beams with LR status (in alternate embodiments, with HR status). In such embodiments, the transmission beam status of the second transmission is determined by the first radio node (e.g., gNB) based on a number and signal strength of the received PRACH (e.g., associated with the first SSB burst), or the signal strength/RSRP of the UL transmissions associated with the first SSB burst, or the computed TA of the UEs based on the UL PRACH transmissions corresponding to the first SSB burst, or an indication (e.g., report) of the UEs for the measured DL SS/PBCH signals of the first set, or the received capability of the UEs for reception of the LR/HR beams, or a combination thereof.

In some embodiments, the set of beams transmitted during the first time-instance includes one or more SS/PBCH transmissions as a subset of beams/directions of an SSB burst, and the set of beams transmitted during the second time-instance includes or more SS/PBCH transmissions corresponding to the same directions of the SS/PBCHs of the first time instance. In other words, the LR/HR mode transition may occur for only a subset of the beams/directions of the SSB burst.

In some embodiments, the set of beams transmitted during the first time-instance includes a set of SS/PBCH transmissions transmitted with beams of HR status (in alternate embodiments, LR status) and the set of beams transmitted during the second time-instance includes a set of CSI-RS (or other RS) and/or one or more DL physical channel transmissions which are transmitted, at least partially, via beams with LR status (in alternate embodiments, with HR status).

In such embodiments, the LR/HR status of the set of beams transmitted during the second time-instance may be determined by the first radio node (e.g., gNB) based on at least the one or more of: the signal strength/RSRP of the UL transmissions associated with the first SSB burst, or an indication/report of the UEs for the measured DL SS/PBCH signals of the first set, or the received capability of the UEs for reception of the LR/HR beams, or the indicated/expected DL data rate for the UE (and an estimate if transmission of the LR or HR beam may be needed for PDSCH/PDCCH transmission), or an indication/recommendation from the UE for utilization of the DL beam, or a combination thereof.

In some examples, to maintain coverage during initial access, the first radio node (e.g., gNB) decides to use an LR beam for DL PDSCH and CSI-RS, based on the first SS/PBCH beam transmitted with HR status (e.g., due to the observation that the PDSCH does not need high data rate or spectral efficiency (SE)). In some other examples, to minimize energy use during initial access, the first radio node (e.g., gNB) decides to use an HR beam for DL PDSCH and CSI-RS, based on the first SS/PBCH beam transmitted with LR status (e.g., due to the observation that the PDSCH needs a high data rate or SE).

In some embodiments, the set of beams transmitted during the first time-instance includes a first set of CSI/RS and/or one or more first DL physical channel transmissions which are transmitted with beams of HR status (in alternate embodiments, LR status) and the set of beams transmitted during the second time-instance includes a second set of CSI-RS (or other RS) and/or one or more second DL physical channel transmissions which are transmitted, at least partially, via beams with LR status (in alternate embodiments, with HR status).

In such embodiments, the LR/HR status of the set of beams transmitted during the second time-instance may be determined by the first radio node (e.g., gNB) based on at least the one or more of: the signal strength/RSRP measurement of the first set of CSI-RS or DL physical channel transmission, or an indication including recommendation or capability of the UE for receiving a beam with an LR status (in alternate embodiments, with HR status), or the detection of a beam failure from the first transmissions, or some combination thereof.

In some examples, to reduce energy consumption, the first radio node (e.g., gNB) transmits a first set of CSI-RS or PDSCH with HR beams, determines to use of LR beam status for the subsequent transmissions of CSI-RS or PDSCH, based on the observation of the achieved link quality and the capability of the UE and the DL traffic demand by the UE. In some other examples, the first radio node (e.g., gNB), transmits a first set of CSI-RS or PDSCH with LR beams, and determines the use of HR beam status for the subsequent transmissions, based on the observation of the archived link quality or signal strength remains below a desired threshold and/or based on the DL traffic demand by the UE.

In some embodiments, the first radio node and the second radio node may be the same node, i.e., a full-duplex radio node. Accordingly, the same radio node both transmits and receives the first signal. In some embodiments, the radio node (e.g., a gNB) transmits a first signal associated with the LR transmit condition and upon observation of a self-interference condition (e.g., where a residual self-interference is above a threshold after cancellation of the self-interference) caused by the transmission and reception of the first signal determines to transmit the second signal with the HR transmit condition in response to the self-interference cancellation. For instance, the radio node may be motivated to obtain accuracy for self-interference cancellation, when the HR transmit condition can be processed with higher accuracy than the LR transmission.

In some embodiments, the transmitted first signal is intended to be used by the same radio node for the purpose of self-interference channel estimation, CSI estimation/measurement, sensing measurement of a physical object, or any other radio measurement based on the joint transmission and reception of the said first signal. In some such embodiments, the determination to transmit the second signal (i.e., at the second time instance) with the HR transmit condition is based on the one or more of the performed measurement not satisfying a required accuracy/reliability or the measurement value not satisfying a threshold.

For example, if a time of arrival (ToA) estimation accuracy of a path associated with a target or a UE device is below a required accuracy/reliability (i.e., for a first signal associated with the LR transmit condition), then the radio node may switch the LR/HR mode and transmit the second signal associated with the HR transmit condition (i.e., in the second time instant). In another example, if the measurement value (e.g., RSRPP) of a path of interest is below a threshold (i.e., for a first signal associated with the LR transmit condition)). As yet another example, if the path of interest is not detectable by the radio node (e.g., gNB), then the radio node may switch the LR/HR mode and transmit the second signal associated with the HR transmit condition (i.e., in the second time instant).

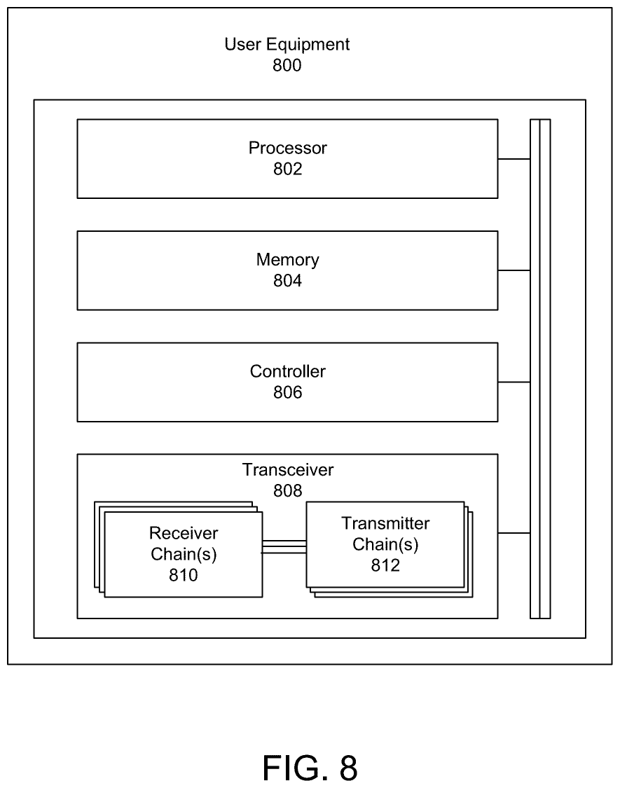

FIG. 8 illustrates an example of a UE 800 in accordance with aspects of the present disclosure. The UE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a central processing unit (CPU), an ASIC, a field programmable gate array (FPGA), or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the UE 800 to perform various functions of the present disclosure.

The memory 804 may include volatile or non-volatile memory. The memory 804 may store computer-readable, computer-executable code including instructions that, when executed by the processor 802, cause the UE 800 to perform various functions described herein. The code may be stored in a non-transitory computer-readable medium such the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the UE 800 to perform one or more of the UE functions described herein (e.g., executing, by the processor 802, instructions stored in the memory 804). Accordingly, the processor 802 may support wireless communication at the UE 800 in accordance with examples as disclosed herein.

In various implementations, the processor 802 may support the functions of a second radio node, in accordance with examples as disclosed herein. For example, the UE 800 may be configured to support a means for receiving (e.g., from a first radio node, which may be a base station) a first signal via a first beam associated with an LR transmit condition. In some embodiments, the LR transmit condition is based on a radio chain comprising low-resolution digital-to-analog converters (DACs) or low resolution analog-to-digital converters (ADCs), or both.

The UE 800 may be configured to support a means for receiving (e.g., from the first radio node) a second signal via a second beam associated with an HR transmit condition. In certain embodiments, the first signal and the second signal are received when the UE 800 is in the connected mode (e.g., RRC_CONNECTED state). In other embodiments, the first signal and the second signal are received while the UE 800 is in the idle mode (e.g., RRC_IDLE state).

In some embodiments, the second signal is received after the first signal is received and the second beam is associated with the HR transmit condition based at least in part on the transmission of a first response associated with the first signal received from the first radio node. Here, the first response may be a report or indication transmitted to the first radio node, e.g., which is generated based at least in part on the reception of the first signal by the UE 800.

In some embodiments, the first signal is received after the second signal is received and the first beam is associated with the LR transmit condition based at least in part on the transmission of a second response associated with the second signal received from the first radio node. Here, the second response may be a report or indication transmitted to the first radio node, e.g., which is generated based at least in part on the reception of the second signal by the UE 800.

In some embodiments, the first signal and the second signal are transmitted simultaneously, where the first beam is associated with the LR transmit condition based at least in part on the second beam being associated with the HR transmit condition or irrespective of whether the second beam is associated with the HR transmit condition. In such embodiments, the first signal and the second signal may be jointly determined.

In some embodiments, the first beam is associated with the LR transmit condition independently from the HR transmit condition of the second beam. In such embodiments, there is no dependency between the first signal and the second signal. In certain embodiments, one or more of the above conditions may be true concurrently.

In some embodiments, the UE 800 is configured to: A) receive (e.g., from the first radio node) configuration information for a transmission of a third signal (e.g., by the UE 800) at least based at least in part on the reception of the first and/or second signal; and B) transmit (e.g., to the first radio node) a third signal based on the transmitted configuration information, wherein the third signal comprises one of the first response or the second response. In certain embodiments, the third signal may indicate the LR status of the reception of the first signal and/or the HR status of the reception of the second signal.

In certain embodiments, the configuration information may comprise, e.g., criteria for beam selection, indication of HR/LR status of a transmission, QCL relation of the first and second signal transmissions, PRACH transmission configuration associated with a detected first signal and/or a PRACH transmission configuration associated with a detected second signal. In certain embodiments, the received third signal may comprise, e.g., a measurement report on the first signal, a PRACH transmission, indication of a selected beam/signal. In some embodiments, the third signal may comprise a CSI report associated with the first beam.

In certain embodiments, the first signal comprises a first SSB burst associated with a first PRACH configuration, and the second signal comprises a second SSB burst associated with a second PRACH configuration. Moreover, the third signal may comprise a PRACH transmission conforming to the first PRACH configuration or the second PRACH configuration. In certain embodiments, the first PRACH configuration and the second PRACH configuration indicate different time-frequency resources for the PRACH transmission, or different sequences for the PRACH transmission, or both.

In some embodiments, the configuration information comprises a beam description indicating an association of the first beam to one or more transmit beams. In certain embodiments, the beam description defines the first beam and indicates that the second beam has the same spatial beam center direction as the first beam. In certain embodiments, the beam description indicates that the first beam is quasi-co-located with the second beam. In such embodiments, the beam description may further define a beam shape of the first beam relative to the second beam.

In certain embodiments, the beam description indicates that the first beam is quasi-co-located with a third beam associated with the LR transmit condition. In such embodiments, the beam description may further define a beam shape common to the first beam and the third beam, a resolution property common to the first beam and the third beam, an energy consumption property of common to the first beam and the third beam, or a combination thereof.

In certain embodiments, the beam description indicates that the first beam is quasi-co-located with the second beam and with a third beam associated with the LR transmit condition. In such embodiments, the beam description may further define a spatial beam center direction of the second beam and a beam shape common to the first beam and the third beam.

In certain embodiments, the beam description indicates that the first beam is quasi-co-located with the second beam and with a third beam associated with the HR transmit condition. In such embodiments, the beam description may further define a spatial pattern of the first beam as a combination of the second beam and the third beam.

In some embodiments, the UE 800 is configured to receive an indication of the LR transmit condition of the first beam (e.g., as part of the transmitted configuration information). In certain embodiments, the indication of the LR transmit condition may include one or more of: information embedded in a payload of a physical control channel, information embedded in a payload of a physical data channel, a downlink control information, or a combination thereof.

In some embodiments, the UE 800 is configured to receive an implicit indicate the LR transmit condition of the first beam. In certain embodiments, the LR transmit condition is implicitly indicated by one or more of: a time-frequency resource associated with the first beam, a sequence type associated with the first signal, or a combination thereof.

In some embodiments, the UE 800 is configured to receive a configuration for a first set of transmit beams associated with the LR transmit condition, where the first set of transmit beams comprises the first beam. In certain embodiments, the configuration indicates a first threshold for the measurement and reporting of the set of transmit beams associated with the LR transmit condition and a second threshold for measurement and reporting of a second set of transmit beams associated with the HR transmit condition, wherein the first threshold is different (e.g., smaller) than the second threshold. In other embodiments, the configuration only indicates the first threshold (i.e., associated with the LR transmit condition), where the second threshold is separately configured, or preconfigured. In one example, the first configuration indicates a difference relative to the second threshold, wherein the UE 800 determines the first threshold based on the indicated difference and the known second threshold (i.e., associated with the HR transmit condition).

In certain embodiments, the configuration indicates a first criterion for ordering measurements associated with the first set of transmit beams and a second criterion for ordering measurements associated with the second set of transmit beams, where the first criterion is different than the second criterion.

In one embodiment, the first criterion for ordering measurements comprises a bias or initial value advantage. In another embodiment, the second criterion for ordering measurements comprises a bias or initial value advantage. In one embodiment, the measurements of the first set of transmit beams comprise a set of RSRP values corresponding to SSBs or CSI-RSs transmitted on the LR beams. In another embodiment, the measurements of the second set of transmit beams comprise a set of RSRP values corresponding to SSBs or CSI-RSs transmitted on the HR beams.

In various implementations, the UE 800 may support the functions of a first radio node, in accordance with examples as disclosed herein. For example, the UE 800 may be configured to support a means for transmitting (e.g., to a second radio node) a first signal via a first beam associated with the LR transmit condition. In some embodiments, the LR transmit condition is based on a radio chain comprising low-resolution DACs or low resolution ADCs, or both.

The UE 800 may be configured to support a means for transmitting (e.g., to the second radio node) a second signal via a second beam associated with the HR transmit condition. In certain embodiments, the first signal and the second signal are transmitted to a second radio node in the connected mode (e.g., RRC_CONNECTED state). In certain embodiments, the first signal and the second signal are transmitted to a second radio node in the idle mode (e.g., RRC_IDLE state).

In some embodiments, the second signal is transmitted after the first signal is transmitted and the second beam is associated with the HR transmit condition based at least in part on a first feedback signal associated with the transmitted first signal. Here, the first feedback signal may be a report or indication received from the second radio node, e.g., which is generated based at least in part on the reception of the first signal by the second radio node.

In some embodiments, the first signal is transmitted after the second signal is transmitted and the first beam is associated with the LR transmit condition based at least in part on a second feedback signal associated with the transmitted second signal. Here, the second feedback signal may be a report or indication received from the second radio node, e.g., which is generated based at least in part on the reception of the second signal by the second radio node.

In some embodiments, the first signal and the second signal are transmitted simultaneously, wherein the first beam is associated with the LR transmit condition based at least in part on the second beam being associated with the HR transmit condition or irrespective of whether the second beam is associated with the HR transmit condition. In such embodiments, the first signal and the second signal may be jointly determined.

In some embodiments, the first beam is associated with the LR transmit condition independently from the HR transmit condition of the second beam. In such embodiments, there is no dependency between the first signal and the second signal. In certain embodiments, one or more of the above conditions may be true concurrently.

In some embodiments, the UE 800 is configured to: A) transmit (e.g., to the second radio node) configuration information for a transmission of a third signal by the second radio node based at least part on the transmitted first and/or second signal; B) receive (e.g., from the radio node) the third signal based on the transmitted configuration information, wherein the third signal comprises one of the first feedback signal or the second feedback signal; and C) determine whether the second radio node is in a LR receive condition or an HR receive condition based on the received third signal. As used herein, the term “LR receive condition” refers to the second radio node being served by a transmit beam with LR status. For example, the second radio node may select a transmit beam with LR status as the best beam (i.e., the beam having highest received power and/or highest signal quality). Similarly, the term “HR receive condition” refers to the second radio node being served by a transmit beam with HR status.

In certain embodiments, the first signal comprises a first SSB burst associated with a first PRACH configuration, and the second signal comprises a second SSB burst associated with a second PRACH configuration. Moreover, the third signal may comprise a PRACH transmission received from the second radio node. In such embodiments, the UE 800 is configured to determine whether an SSB corresponding to the received PRACH transmission is associated with the LR transmit condition or the HR transmit condition based at least in part on whether the PRACH transmission is according to the first PRACH configuration or the second PRACH configuration, wherein the SSB is associated with the first SSB burst or the second SSB burst.

In some embodiments, the UE 800 is configured to transmit an indication of the LR transmit condition of the first beam (e.g., as part of the transmitted configuration information). In certain embodiments, the UE 800 is configured to implicitly indicate the LR transmit condition of the first beam. In some embodiments, the UE 800 is configured to transmit a configuration for a first set of transmit beams associated with the LR transmit condition, wherein the first set of beams comprises the first beam.

The controller 806 may manage input and output signals for the UE 800. The controller 806 may also manage peripherals not integrated into the UE 800. In some implementations, the controller 806 may utilize an operating system (OS) such as iOS®, ANDROID®, WINDOWS®, or other operating systems. In some implementations, the controller 806 may be implemented as part of the processor 802.

In some implementations, the UE 800 may include at least one transceiver 808. In some other implementations, the UE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas for receiving the signal over the air or wireless medium. The receiver chain 810 may include at least one amplifier (e.g., a low-noise amplifier (LNA)) configured to amplify the received signal. The receiver chain 810 may include at least one demodulator configured to demodulate the received signal and obtain the transmitted data by reversing the modulation technique applied during transmission of the signal. The receiver chain 810 may include at least one decoder for decoding/processing the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

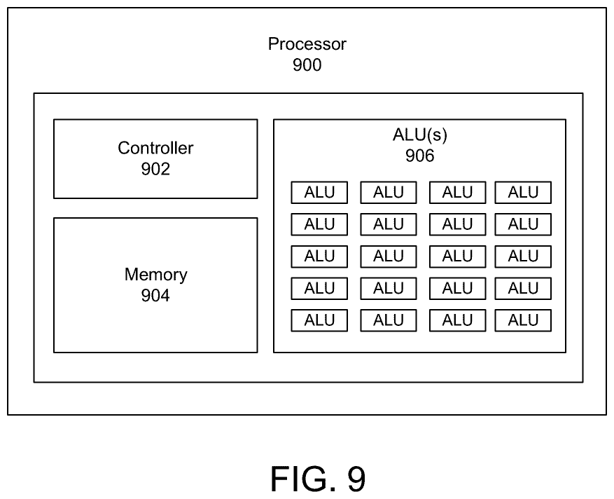

FIG. 9 illustrates an example of a processor 900 in accordance with aspects of the present disclosure. The processor 900 may be an example of a processor configured to perform various operations in accordance with examples as described herein. The processor 900 may include a controller 902 configured to perform various operations in accordance with examples as described herein. The processor 900 may optionally include at least one memory 904, which may be, for example, an L1/L2/L3 cache. Additionally, or alternatively, the processor 900 may optionally include one or more arithmetic-logic units (ALUs) 906. One or more of these components may be in electronic communication or otherwise coupled (e.g., operatively, communicatively, functionally, electronically, electrically) via one or more interfaces (e.g., buses).

The processor 900 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 900) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 902 may be configured to manage and coordinate various operations (e.g., signaling, receiving, obtaining, retrieving, transmitting, outputting, forwarding, storing, determining, identifying, accessing, writing, reading) of the processor 900 to cause the processor 900 to support various operations in accordance with examples as described herein. For example, the controller 902 may operate as a control unit of the processor 900, generating control signals that manage the operation of various components of the processor 900. These control signals include enabling or disabling functional units, selecting data paths, initiating memory access, and coordinating timing of operations.

The controller 902 may be configured to fetch (e.g., obtain, retrieve, receive) instructions from the memory 904 and determine subsequent instruction(s) to be executed to cause the processor 900 to support various operations in accordance with examples as described herein. The controller 902 may be configured to track memory address of instructions associated with the memory 904. The controller 902 may be configured to decode instructions to determine the operation to be performed and the operands involved. For example, the controller 902 may be configured to interpret the instruction and determine control signals to be output to other components of the processor 900 to cause the processor 900 to support various operations in accordance with examples as described herein. Additionally, or alternatively, the controller 902 may be configured to manage flow of data within the processor 900. The controller 902 may be configured to control transfer of data between registers, arithmetic logic units (ALUs), and other functional units of the processor 900.

The memory 904 may include one or more caches (e.g., memory local to or included in the processor 900 or other memory, such RAM, ROM, DRAM, SDRAM, SRAM, MRAM, flash memory, etc. In some implementations, the memory 904 may reside within or on a processor chipset (e.g., local to the processor 900). In some other implementations, the memory 904 may reside external to the processor chipset (e.g., remote to the processor 900).

The memory 904 may store computer-readable, computer-executable code including instructions that, when executed by the processor 900, cause the processor 900 to perform various functions described herein. The code may be stored in a non-transitory computer-readable medium such as system memory or another type of memory. The controller 902 and/or the processor 900 may be configured to execute computer-readable instructions stored in the memory 904 to cause the processor 900 to perform various functions. For example, the processor 900 and/or the controller 902 may be coupled with or to the memory 904, the processor 900, the controller 902, and the memory 904 may be configured to perform various functions described herein. In some examples, the processor 900 may include multiple processors and the memory 904 may include multiple memories. One or more of the multiple processors may be coupled with one or more of the multiple memories, which may, individually or collectively, be configured to perform various functions herein.

The one or more ALUs 906 may be configured to support various operations in accordance with examples as described herein. In some implementations, the one or more ALUs 906 may reside within or on a processor chipset (e.g., the processor 900). In some other implementations, the one or more ALUs 906 may reside external to the processor chipset (e.g., the processor 900). One or more ALUs 906 may perform one or more computations such as addition, subtraction, multiplication, and division on data. For example, one or more ALUs 906 may receive input operands and an operation code, which determines an operation to be executed. One or more ALUs 906 be configured with a variety of logical and arithmetic circuits, including adders, subtractors, shifters, and logic gates, to process and manipulate the data according to the operation. Additionally, or alternatively, the one or more ALUs 906 may support logical operations such as AND, OR, exclusive-OR (XOR), not-OR (NOR), and not-AND (NAND), enabling the one or more ALUs 906 to handle conditional operations, comparisons, and bitwise operations.

In various implementations, the processor 900 may support the functions of a UE, in accordance with examples as disclosed herein. For example, the processor 900 may be configured to support a means for receiving (e.g., from a radio node, which may be a base station) a first signal via a first beam associated with an LR transmit condition. In some embodiments, the LR transmit condition is based on a radio chain comprising low-resolution DACs or low resolution ADCs, or both.

The processor 900 may be configured to support a means for receiving (e.g., from the radio node/base station) a second signal via a second beam associated with an HR transmit condition. In certain embodiments, the first signal and the second signal are received when the UE is in the connected mode (e.g., RRC_CONNECTED state). In other embodiments, the first signal and the second signal are received while the UE is in the idle mode (e.g., RRC_IDLE state).

In some embodiments, the second signal is received after the first signal is received and the second beam is associated with the HR transmit condition based at least in part on the transmission of a first response signal associated with the first signal received from the base station. Here, the first response signal may be a report or indication transmitted to the base station, e.g., which is generated based at least in part on the reception of the first signal.

In some embodiments, the first signal is received after the second signal is received and the first beam is associated with the LR transmit condition based at least in part on the transmission of a second response signal associated with the second signal received from the base station. Here, the second response signal may be a report or indication transmitted to the base station, e.g., which is generated based at least in part on the reception of the second signal.

In some embodiments, the first signal and the second signal are transmitted simultaneously, where the first beam is associated with the LR transmit condition based at least in part on the second beam being associated with the HR transmit condition or irrespective of whether the second beam is associated with the HR transmit condition. In such embodiments, the first signal and the second signal may be jointly determined.

In some embodiments, the first beam is associated with the LR transmit condition independently from the HR transmit condition of the second beam. In such embodiments, there is no dependency between the first signal and the second signal. In certain embodiments, one or more of the above conditions may be true concurrently.

In some embodiments, the processor 900 is configured to: A) receive (e.g., from the radio node/base station) configuration information for a transmission of a third signal (e.g., by the UE) based at least in part on the reception of the first and/or second signal; and B) transmit (e.g., to the radio node/base station) a third signal based on the transmitted configuration information, wherein the third signal comprises one of the first response signal or the second response signal. In certain embodiments, the third signal may indicate the LR status of the reception of the first signal and/or the HR status of the reception of the second signal.

In certain embodiments, the configuration information may comprise, e.g., criteria for beam selection, indication of HR/LR status of a transmission, QCL relation of the first and second signal transmissions, PRACH transmission configuration associated with a detected first signal and/or a PRACH transmission configuration associated with a detected second signal. In certain embodiments, the received third signal may comprise, e.g., a measurement report on the first signal, a PRACH transmission, indication of a selected beam/signal. In some embodiments, the third signal may comprise a CSI report associated with the first beam.

In certain embodiments, the first signal comprises a first SSB burst associated with a first PRACH configuration, and the second signal comprises a second SSB burst associated with a second PRACH configuration. Moreover, the third signal may comprise a PRACH transmission conforming to the first PRACH configuration or the second PRACH configuration. In certain embodiments, the first PRACH configuration and the second PRACH configuration indicate different time-frequency resources for the PRACH transmission, or different sequences for the PRACH transmission, or both.

In some embodiments, the configuration information comprises a beam description indicating an association of the first beam to one or more transmit beams. In certain embodiments, the beam description defines the first beam and indicates that the second beam has the same spatial beam center direction as the first beam. In certain embodiments, the beam description indicates that the first beam is quasi-co-located with the second beam. In such embodiments, the beam description may further define a beam shape of the first beam relative to the second beam.

In certain embodiments, the beam description indicates that the first beam is quasi-co-located with a third beam associated with the LR transmit condition. In such embodiments, the beam description may further define a beam shape common to the first beam and the third beam, a resolution property common to the first beam and the third beam, an energy consumption property of common to the first beam and the third beam, or a combination thereof.

In certain embodiments, the beam description indicates that the first beam is quasi-co-located with the second beam and with a third beam associated with the LR transmit condition. In such embodiments, the beam description may further define a spatial beam center direction of the second beam and a beam shape common to the first beam and the third beam.

In certain embodiments, the beam description indicates that the first beam is quasi-co-located with the second beam and with a third beam associated with the HR transmit condition. In such embodiments, the beam description may further define a spatial pattern of the first beam as a combination of the second beam and the third beam.

In some embodiments, the processor 900 is configured to receive an indication of the LR transmit condition of the first beam (e.g., as part of the transmitted configuration information). In certain embodiments, the indication of the LR transmit condition may include one or more of: information embedded in a payload of a physical control channel, information embedded in a payload of a physical data channel, a downlink control information, or a combination thereof.

In some embodiments, the processor 900 is configured to receive an implicit indicate the LR transmit condition of the first beam. In certain embodiments, the LR transmit condition is implicitly indicated by one or more of: a time-frequency resource associated with the first beam, a sequence type associated with the first signal, or a combination thereof.

In some embodiments, the processor 900 is configured to receive a configuration for a first set of transmit beams associated with the LR transmit condition, wherein the first set of transmit beams includes the first beam. In certain embodiments, the configuration indicates a first threshold for measurement and reporting of the first set of transmit beams associated with the LR transmit condition and a second threshold for measurement and reporting of a second set of transmit beams associated with the HR transmit condition, wherein the first threshold is different (e.g., smaller) than the second threshold. In other embodiments, the configuration only indicates the first threshold (i.e., associated with the LR transmit condition), where the second threshold is separately configured, or preconfigured. In one example, the first configuration indicates a difference relative to the second threshold, wherein the processor 900 determines the first threshold based on the indicated difference and the known second threshold (i.e., associated with the HR transmit condition).

In certain embodiments, the configuration indicates a first criterion for ordering measurements associated with the first set of transmit beams and a second criterion for ordering measurements associated with the second set of transmit beams, where the first criterion is different than the second criterion.

In one embodiment, the first criterion for ordering measurements comprises a bias or initial value advantage. In another embodiment, the second criterion for ordering measurements comprises a bias or initial value advantage. In one embodiment, the measurements of the first set of transmit beams comprise a set of RSRP values corresponding to SSBs or CSI-RSs transmitted on the LR beams. In another embodiment, the measurements of the second set of transmit beams comprise a set of RSRP values corresponding to SSBs or CSI-RSs transmitted on the HR beams.

In various implementations, the processor 900 may support the functions of a base station, in accordance with examples as disclosed herein. For example, the processor 900 may be configured to support a means for transmitting (e.g., to a radio node, which may be a UE) a first signal via a first beam associated with an LR transmit condition. In some embodiments, the LR transmit condition is based on a radio chain comprising low-resolution DACs or low resolution ADCs, or both.

The processor 900 may be configured to support a means for transmitting (e.g., to the radio node) a second signal via a second beam associated with an HR transmit condition. In certain embodiments, the first signal and the second signal are transmitted to a UE in the connected mode (e.g., RRC_CONNECTED state). In certain embodiments, the first signal and the second signal are transmitted to a UE in the idle mode (e.g., RRC_IDLE state).

In some embodiments, the second signal is transmitted after the first signal is transmitted and the second beam is associated with the HR transmit condition based at least in part on a first response signal associated with the transmitted first signal. Here, the first response signal may be a report or indication received from the radio node, e.g., which is generated based at least in part on the reception of the first signal by the radio node.

In some embodiments, the first signal is transmitted after the second signal is transmitted and the first beam is associated with the LR transmit condition based at least in part on a second response signal associated with the transmitted second signal. Here, the second response signal may be a report or indication received from the radio node, e.g., which is generated based at least in part on the reception of the second signal by the radio node.

In some embodiments, the first signal and the second signal are transmitted simultaneously, wherein the first beam is associated with the LR transmit condition based at least in part on the second beam being associated with the HR transmit condition or irrespective of whether the second beam is associated with the HR transmit condition. In such embodiments, the first signal and the second signal may be jointly determined.

In some embodiments, the first beam is associated with the LR transmit condition independently from the HR transmit condition of the second beam. In such embodiments, there is no dependency between the first signal and the second signal. In certain embodiments, one or more of the above conditions may be true concurrently.

In some embodiments, the processor 900 is configured to: A) transmit (e.g., to the radio node) configuration information for a transmission of a third signal (e.g., by the radio node) based at least in part on the transmitted first and/or second signal; B) receive (e.g., from the radio node) a third signal based on the transmitted configuration information, wherein the third signal comprises one of the first response signal or the second response signal; and C) determine whether the radio node is in an LR receive condition or an HR receive condition based on the received third signal.

In certain embodiments, the configuration information may comprise, e.g., criteria for beam selection, indication of HR/LR status of a transmission, QCL relation of the first and second signal transmissions, PRACH transmission configuration associated with a detected first signal and/or a PRACH transmission configuration associated with a detected second signal. In certain embodiments, the received third signal may comprise, e.g., a measurement report on the first signal, a PRACH transmission, indication of a selected beam/signal. In some embodiments, the third signal may comprise a CSI report associated with the first beam.

In certain embodiments, the first signal comprises a first SSB burst associated with a first PRACH configuration, and the second signal comprises a second SSB burst associated with a second PRACH configuration. Moreover, the third signal may comprise a PRACH transmission received from the radio node (e.g., a UE). In such embodiments, the processor 900 is configured to determine whether an SSB corresponding to the received PRACH transmission is associated with the LR transmit condition or the HR transmit condition based at least in part on whether the PRACH transmission is received according to the first PRACH configuration or the second PRACH configuration, where the SSB is associated with the first SSB burst or the second SSB burst.

In certain embodiments, the first PRACH configuration and the second PRACH configuration indicate different time-frequency resources for the PRACH transmission, or different sequences for the PRACH transmission, or both.

In some embodiments, the configuration information comprises a beam description indicating an association of the first beam to one or more transmit beams. In certain embodiments, the beam description defines the first beam and indicates that the second beam has the same spatial beam center direction as the first beam.

In certain embodiments, the beam description indicates that the first beam is quasi-co-located with the second beam. In such embodiments, the beam description may further define a beam shape of the first beam relative to the second beam.

In certain embodiments, the beam description indicates that the first beam is quasi-co-located with a third beam associated with the LR transmit condition. In such embodiments, the beam description may further define a beam shape common to the first beam and the third beam, a resolution property common to the first beam and the third beam, an energy consumption property of common to the first beam and the third beam, or a combination thereof.

In certain embodiments, the beam description indicates that the first beam is quasi-co-located with the second beam and with a third beam associated with the LR transmit condition. In such embodiments, the beam description may further define a spatial beam center direction of the second beam and a beam shape common to the first beam and the third beam.

In certain embodiments, the beam description indicates that the first beam is quasi-co-located with the second beam and with a third beam associated with the HR transmit condition. In such embodiments, the beam description may further define a spatial pattern of the first beam as a combination of the second beam and the third beam.

In some embodiments, the processor 900 is configured to transmit an indication of the LR transmit condition of the first beam (e.g., as part of the transmitted configuration information). In certain embodiments, the indication of the LR transmit condition may include one or more of: information embedded in a payload of a physical control channel, information embedded in a payload of a physical data channel, a downlink control information, or a combination thereof.

In some embodiments, the processor 900 is configured to implicitly indicate the LR transmit condition of the first beam. In certain embodiments, the LR transmit condition is implicitly indicated by one or more of: a time-frequency resource associated with the first beam, a sequence type associated with the first signal, or a combination thereof.

In some embodiments, the processor 900 is configured to transmit a configuration for a first set of transmit beams associated with the LR transmit condition, where the first set of transmit beams includes the first beam. In certain embodiments, the configuration indicates a first threshold for measurement and reporting of the first set of transmit beams associated with the LR transmit condition and a second threshold for measurement and reporting of a second set of transmit beams associated with the HR transmit condition, wherein the first threshold is different (e.g., smaller) than the second threshold. In other embodiments, the configuration only indicates the first threshold (i.e., associated with the LR transmit condition), where the second threshold is separately configured, or preconfigured. In one example, the first configuration indicates a difference relative to a known second threshold (i.e., associated with the HR transmit condition).

In certain embodiments, the configuration indicates a first criterion for ordering measurements of the first set of transmit beams and a second criterion for ordering measurements of a second set of transmit beams, where the first criterion is different than the second criterion.

In one embodiment, the first criterion for ordering measurements comprises a bias or initial value advantage. In another embodiment, the second criterion for ordering measurements comprises a bias or initial value advantage. In one embodiment, the measurements of the first set of transmit beams comprise a set of RSRP values corresponding to SSBs or CSI-RSs transmitted on the LR beams. In another embodiment, the measurements of the second set of transmit beams comprise a set of RSRP values corresponding to SSBs or CSI-RSs transmitted on the HR beams.

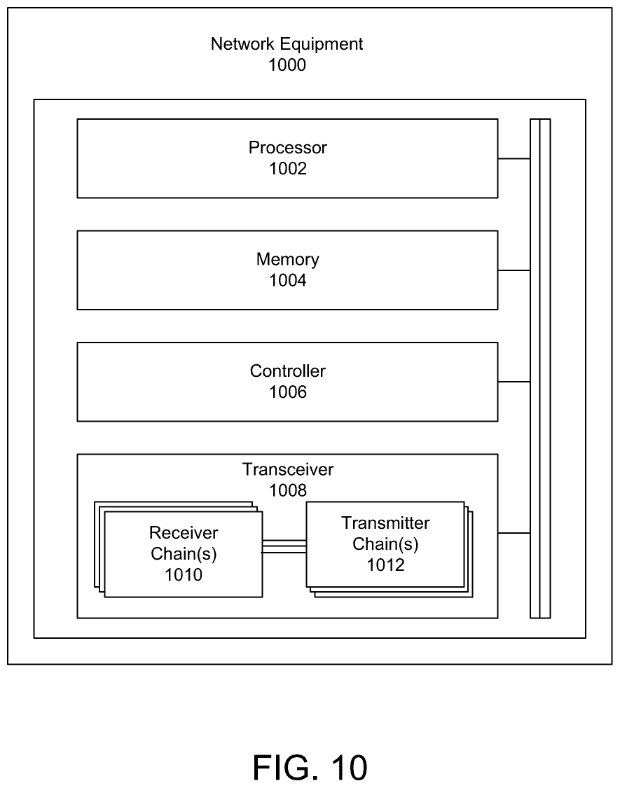

FIG. 10 illustrates an example of an NE 1000 in accordance with aspects of the present disclosure. The NE 1000 may include a processor 1002, a memory 1004, a controller 1006, and a transceiver 1008. The processor 1002, the memory 1004, the controller 1006, or the transceiver 1008, or various combinations thereof or various components thereof may be examples of means for performing various aspects of the present disclosure as described herein. These components may be coupled (e.g., operatively, communicatively, functionally, electronically, electrically) via one or more interfaces.

The processor 1002, the memory 1004, the controller 1006, or the transceiver 1008, or various combinations or components thereof may be implemented in hardware (e.g., circuitry). The hardware may include a processor, a DSP, an ASIC, or other programmable logic device, or any combination thereof configured as or otherwise supporting a means for performing the functions described in the present disclosure.

The processor 1002 may include an intelligent hardware device (e.g., a general-purpose processor, a DSP, a CPU, an ASIC, an FPGA, or any combination thereof). In some implementations, the processor 1002 may be configured to operate the memory 1004. In some other implementations, the memory 1004 may be integrated into the processor 1002. The processor 1002 may be configured to execute computer-readable instructions stored in the memory 1004 to cause the NE 1000 to perform various functions of the present disclosure.

The memory 1004 may include volatile or non-volatile memory. The memory 1004 may store computer-readable, computer-executable code including instructions when executed by the processor 1002 cause the NE 1000 to perform various functions described herein. The code may be stored in a non-transitory computer-readable medium such the memory 1004 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1002 and the memory 1004 coupled with the processor 1002 may be configured to cause the NE 1000 to perform one or more base station functions as described herein (e.g., executing, by the processor 1002, instructions stored in the memory 1004). Accordingly, the processor 1002 may support the communication at the NE 1000 in accordance with examples as disclosed herein.

In various implementations, the NE 1000 may support the functions of a first radio node, in accordance with examples as disclosed herein. For example, the NE 1000 may be configured to support a means for transmitting (e.g., to a second radio node) a first signal via a first beam associated with an LR transmit condition. In some embodiments, the LR transmit condition is based on a radio chain comprising low-resolution DACs or low resolution ADCs, or both.

The NE 1000 may be configured to support a means for transmitting (e.g., to the second radio node) a second signal via a second beam associated with an HR transmit condition. In certain embodiments, the first signal and the second signal are transmitted to a second radio node in the connected mode (e.g., RRC_CONNECTED state). In certain embodiments, the first signal and the second signal are transmitted to a second radio node in the idle mode (e.g., RRC_IDLE state).

In some embodiments, the second signal is transmitted after the first signal is transmitted and the second beam is associated with the HR transmit condition based at least in part on a first response associated with the transmitted first signal. Here, the first response may be a report or indication received from the second radio node, e.g., which is generated based at least in part on the reception of the first signal by the second radio node.

In some embodiments, the first signal is transmitted after the second signal is transmitted and the first beam is associated with the LR transmit condition based at least in part on a second response associated with the transmitted second signal. Here, the second response may be a report or indication received from the second radio node, e.g., which is generated based at least in part on the reception of the second signal by the second radio node.

In some embodiments, the first signal and the second signal are transmitted simultaneously, wherein the first beam is associated with the LR transmit condition based at least in part on the second beam being associated with the HR transmit condition or irrespective of whether the second beam is associated with the HR transmit condition. In such embodiments, the first signal and the second signal may be jointly determined.

In some embodiments, the first beam is associated with the LR transmit condition independently from the HR transmit condition of the second beam. In such embodiments, there is no dependency between the first signal and the second signal. In certain embodiments, one or more of the above conditions may be true concurrently.

In some embodiments, the NE 1000 is configured to: A) transmit (e.g., to the second radio node, which may be a UE) configuration information for a transmission of a third signal (e.g., by the second radio node) based at least in part on the transmitted first and/or second signal; B) receive (e.g., from the second radio node) a third signal based on the transmitted configuration information, wherein the third signal comprises one of the first response or the second response; and C) determine whether the radio node is in an LR receive condition or an HR receive condition based on the received third signal.

In certain embodiments, the configuration information may comprise, e.g., criteria for beam selection, indication of HR/LR status of a transmission, QCL relation of the first and second signal transmissions, PRACH transmission configuration associated with a detected first signal and/or a PRACH transmission configuration associated with a detected second signal. In certain embodiments, the received third signal may comprise, e.g., a measurement report on the first signal, a PRACH transmission, indication of a selected beam/signal. In some embodiments, the third signal may comprise a CSI report associated with the first beam.

In certain embodiments, the first signal comprises a first SSB burst associated with a first PRACH configuration, and the second signal comprises a second SSB burst associated with a second PRACH configuration. Moreover, the third signal may comprise a PRACH transmission received from the second radio node. In such embodiments, the NE 1000 is configured to determine whether an SSB corresponding to the received PRACH transmission is associated with the LR transmit condition or the HR transmit condition based at least in part on whether the PRACH transmission is received according to the first PRACH configuration or the second PRACH configuration, wherein the SSB is associated with the first SSB burst or the second SSB burst.

In certain embodiments, the first PRACH configuration and the second PRACH configuration indicate different time-frequency resources for the PRACH transmission, or different sequences for the PRACH transmission, or both.

In some embodiments, the configuration information comprises a beam description indicating an association of the first beam to one or more transmit beams. In certain embodiments, the beam description defines the first beam and indicates that the second beam has the same spatial beam center direction as the first beam.

In certain embodiments, the beam description indicates that the first beam is quasi-co-located with the second beam. In such embodiments, the beam description may further define a beam shape of the first beam relative to the second beam.

In certain embodiments, the beam description indicates that the first beam is quasi-co-located with a third beam associated with the LR transmit condition. In such embodiments, the beam description may further define a beam shape common to the first beam and the third beam, a resolution property common to the first beam and the third beam, an energy consumption property of common to the first beam and the third beam, or a combination thereof.

In certain embodiments, the beam description indicates that the first beam is quasi-co-located with the second beam and with a third beam associated with the LR transmit condition. In such embodiments, the beam description may further define a spatial beam center direction of the second beam and a beam shape common to the first beam and the third beam.

In certain embodiments, the beam description indicates that the first beam is quasi-co-located with the second beam and with a third beam associated with the HR transmit condition. In such embodiments, the beam description may further define a spatial pattern of the first beam as a combination of the second beam and the third beam.

In some embodiments, the NE 1000 is configured to transmit an indication of the LR transmit condition of the first beam (e.g., as part of the transmitted configuration information). In certain embodiments, the indication of the LR transmit condition may include one or more of: information embedded in a payload of a physical control channel, information embedded in a payload of a physical data channel, a downlink control information, or a combination thereof.

In some embodiments, the NE 1000 is configured to implicitly indicate the LR transmit condition of the first beam. In certain embodiments, the LR transmit condition is implicitly indicated by one or more of: a time-frequency resource associated with the first beam, a sequence type associated with the first signal, or a combination thereof.

In some embodiments, the NE 1000 is configured to transmit a configuration for a first set of transmit beams associated with the LR transmit condition, where the first set of transmit beams includes the first beam. In certain embodiments, the configuration indicates a first threshold for measurement and reporting of the first set of transmit beams associated with the LR transmit condition and a second threshold for measurement and reporting of a second set of transmit beams associated with the HR transmit condition, wherein the first threshold is different (e.g., smaller) than the second threshold. In other embodiments, the configuration only indicates the first threshold (i.e., associated with the LR transmit condition), where the second threshold is separately configured, or preconfigured. In one example, the first configuration indicates a difference relative to a known second threshold (i.e., associated with the HR transmit condition).

In certain embodiments, the configuration indicates a first criterion for ordering measurements of the first set of transmit beams and a second criterion for ordering measurements of a second set of transmit beams, where the first criterion is different than the second criterion.

In one embodiment, the first criterion for ordering measurements comprises a bias or initial value advantage. In another embodiment, the second criterion for ordering measurements comprises a bias or initial value advantage. In one embodiment, the measurements of the first set of transmit beams comprise a set of RSRP values corresponding to SSBs or CSI-RSs transmitted on the LR beams. In another embodiment, the measurements of the second set of transmit beams comprise a set of RSRP values corresponding to SSBs or CSI-RSs transmitted on the HR beams.

In various implementations, the NE 1000 may support the functions of a second radio node, in accordance with examples as disclosed herein. For example, the NE 1000 may be configured to support a means for receiving (e.g., from a first radio node) a first signal via a first beam associated with an LR transmit condition. In some embodiments, the LR transmit condition is based on a radio chain comprising low-resolution DACs or low resolution ADCs, or both.

The NE 1000 may be configured to support a means for receiving (e.g., from the first radio node) a second signal via a second beam associated with an HR transmit condition. In certain embodiments, the first signal and the second signal are received when the NE 1000 is in the connected mode (e.g., RRC_CONNECTED state). In other embodiments, the first signal and the second signal are received while the NE 1000 is in the idle mode (e.g., RRC_IDLE state).

In some embodiments, the second signal is received after the first signal is received and the second beam is associated with the HR transmit condition based at least in part on the transmission of a first feedback signal associated with the first signal received from the first radio node. Here, the first feedback signal may be a report or indication transmitted to the first radio node, e.g., which is generated based at least in part on the reception of the first signal by the NE 1000.

In some embodiments, the first signal is received after the second signal is received and the first beam is associated with the LR transmit condition based at least in part on the transmission of a second feedback signal associated with the second signal received from the first radio node. Here, the second feedback signal may be a report or indication transmitted to the first radio node, e.g., which is generated based at least in part on the reception of the second signal by the NE 1000.

In some embodiments, the first signal and the second signal are transmitted simultaneously, where the first beam is associated with the LR transmit condition based at least in part on the second beam being associated with the HR transmit condition or irrespective of whether the second beam is associated with the HR transmit condition. In such embodiments, the first signal and the second signal may be jointly determined.

In some embodiments, the first beam is associated with the LR transmit condition independently from the HR transmit condition of the second beam. In such embodiments, there is no dependency between the first signal and the second signal. In certain embodiments, one or more of the above conditions may be true concurrently.

In some embodiments, the NE 1000 is configured to: A) receive (e.g., from the first radio node) configuration information for a transmission of a third signal (e.g., by the NE 1000) based at least in part on the reception of the first and/or second signal; and B) transmit (e.g., to the first radio node) a third signal based on the transmitted configuration information, wherein the third signal comprises one of the first feedback signal or the second feedback signal. In certain embodiments, the third signal may indicate the LR status of the reception of the first signal and/or the HR status of the reception of the second signal.

In certain embodiments, the first signal comprises a first SSB burst associated with a first PRACH configuration, and the second signal comprises a second SSB burst associated with a second PRACH configuration. Moreover, the third signal may comprise a PRACH transmission conforming to the first PRACH configuration or the second PRACH configuration.

In some embodiments, the NE 1000 is configured to receive an indication of the LR transmit condition of the first beam (e.g., as part of the transmitted configuration information). In certain embodiments, the NE 1000 may be configured to receive an implicit indicate the LR transmit condition of the first beam.

In some embodiments, the NE 1000 is configured to receive a configuration for a first set of transmit beams associated with the LR transmit condition, where the first set of transmit beams includes the first beam.

The controller 1006 may manage input and output signals for the NE 1000. The controller 1006 may also manage peripherals not integrated into the NE 1000. In some implementations, the controller 1006 may utilize an operating system such as iOS®, ANDROID®, WINDOWS®, or other operating systems. In some implementations, the controller 1006 may be implemented as part of the processor 1002.

In some implementations, the NE 1000 may include at least one transceiver 1008. In some other implementations, the NE 1000 may have more than one transceiver 1008. The transceiver 1008 may represent a wireless transceiver. The transceiver 1008 may include one or more receiver chains 1010, one or more transmitter chains 1012, or a combination thereof.

A receiver chain 1010 may be configured to receive signals (e.g., control information, data, packets) over a wireless medium. For example, the receiver chain 1010 may include one or more antennas for receiving the signal over the air or wireless medium. The receiver chain 1010 may include at least one amplifier (e.g., a low-noise amplifier (LNA)) configured to amplify the received signal. The receiver chain 1010 may include at least one demodulator configured to demodulate the received signal and obtain the transmitted data by reversing the modulation technique applied during transmission of the signal. The receiver chain 1010 may include at least one decoder for decoding/processing the demodulated signal to receive the transmitted data.

A transmitter chain 1012 may be configured to generate and transmit signals (e.g., control information, data, packets). The transmitter chain 1012 may include at least one modulator for modulating data onto a carrier signal, preparing the signal for transmission over a wireless medium. The at least one modulator may be configured to support one or more techniques such as AM, FM, or digital modulation schemes like PSK or QAM. The transmitter chain 1012 may also include at least one power amplifier configured to amplify the modulated signal to an appropriate power level suitable for transmission over the wireless medium. The transmitter chain 1012 may also include one or more antennas for transmitting the amplified signal into the air or wireless medium.

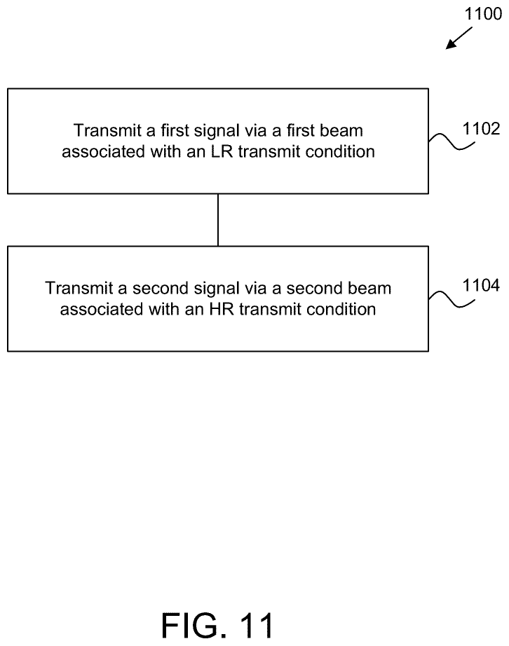

FIG. 11 depicts one embodiment of a method 1100 in accordance with aspects of the present disclosure. In various embodiments, the operations of the method 1100 may be implemented by a base station, as described herein. In some implementations, the base station may execute a set of instructions to control the function elements of the base station to perform the described functions.

At step 1102, the method 1100 may include transmitting a first signal via a first beam associated with an LR transmit condition. The operations of step 1102 may be performed in accordance with examples as described herein. In some implementations, aspects of the operations of step 1102 may be performed by an NE, as described with reference to FIG. 10.

At step 1104, the method 1100 may include transmitting a second signal via a second beam associated with an HR transmit condition. The operations of step 1104 may be performed in accordance with examples as described herein. In some implementations, aspects of the operations of step 1104 may be performed by an NE, as described with reference to FIG. 10.

In some embodiments, the transmission of the second signal (step 1104) occurs after the transmission of the first signal (step 1102), and the second beam is associated with the HR transmit condition based at least in part on a first response associated with the transmitted first signal.

In some embodiments, the transmission of the first signal (step 1102) occurs after the transmission of the second signal (step 1104), and the first beam is associated with the LR transmit condition based at least in part on a second response associated with the transmitted second signal.

In some embodiments, the transmission of the first signal (step 1102) and the transmission of the second signal (step 1104) occur simultaneously, wherein the first beam is associated with the LR transmit condition based at least in part on the second beam being associated with the HR transmit condition or irrespective of whether the second beam is associated with the HR transmit condition.

It should be noted that the method 1100 described herein describes one possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A base station for wireless communication, comprising:
at least one memory; and
at least one processor coupled with the at least one memory and configured to cause the base station to:
transmit a first signal via a first beam and a second signal via a second beam, the first beam is associated with a low-resolution (LR) transmit condition and the second beam is associated with a high-resolution (HR) transmit condition,
wherein:
the second signal is transmitted after the first signal is transmitted and the second beam is associated with the HR transmit condition based at least in part on a first response associated with the first signal, or
the first signal is transmitted after the second signal is transmitted and the first beam is associated with the LR transmit condition based at least in part on a second response associated with the second signal, or
the first signal and the second signal are transmitted simultaneously, the first beam is associated with the LR transmit condition based at least in part on the second beam being associated with the HR transmit condition or irrespective of whether the second beam is associated with the HR transmit condition.

2. The base station of claim 1, wherein the at least one processor is configured to cause the base station to:
transmit configuration information for a transmission of a third signal by a radio node based at least in part on the transmitted first signal or the transmitted second signal, or both;
receive the third signal from the radio node based on the transmitted configuration information, wherein the third signal comprises one of the first response or the second response; and
determine whether the radio node is in a LR receive condition or an HR receive condition based on the received third signal.

3. The base station of claim 2, wherein the third signal comprises a channel state information (CSI) report associated with the first beam.

4. The base station of claim 2, wherein the first signal comprises a first synchronization signal block (SSB) burst associated with a first physical random access channel (PRACH) configuration, wherein the second signal comprises a second SSB burst associated with a second PRACH configuration, wherein the third signal comprises a PRACH transmission received from the radio node, and wherein the at least one processor is configured to cause the base station to:
determine whether an SSB corresponding to the received PRACH transmission is associated with the LR transmit condition or the HR transmit condition based at least in part on whether the PRACH transmission is received according to the first PRACH configuration or the second PRACH configuration, wherein the SSB is associated with the first SSB burst or the second SSB burst.

5. The base station of claim 4, wherein the first PRACH configuration and the second PRACH configuration indicate different time-frequency resources for the PRACH transmission, or different sequences for the PRACH transmission, or both.

6. The base station of claim 2, wherein the configuration information comprises a beam description indicating an association of the first beam to one or more transmit beams, and wherein the beam description defines the first beam and indicates that the second beam has a same spatial beam center direction as the first beam.

7. The base station of claim 2, wherein the configuration information comprises a beam description indicating an association of the first beam to one or more transmit beams, wherein the beam description indicates that the first beam is quasi-co-located with the second beam, and wherein the beam description further defines a beam shape of the first beam relative to the second beam.

8. The base station of claim 2, wherein the configuration information comprises a beam description indicating an association of the first beam to one or more transmit beams, wherein the beam description indicates that the first beam is quasi-co-located with a third beam associated with the LR transmit condition, and wherein the beam description further defines a beam shape common to the first beam and the third beam, a resolution property common to the first beam and the third beam, an energy consumption property of common to the first beam and the third beam, or a combination thereof.

9. The base station of claim 2, wherein the configuration information comprises a beam description indicating an association of the first beam to one or more transmit beams, wherein the beam description indicates that the first beam is quasi-co-located with the second beam and with a third beam associated with the LR transmit condition, and wherein the beam description further defines a spatial beam center direction of the second beam and a beam shape common to the first beam and the third beam.

10. The base station of claim 2, wherein the configuration information comprises a beam description indicating an association of the first beam to one or more transmit beams, wherein the beam description indicates that the first beam is quasi-co-located with the second beam and with a third beam associated with the HR transmit condition, and wherein the beam description further defines a spatial pattern of the first beam as a combination of the second beam and the third beam.

11. The base station of claim 1, wherein the LR transmit condition is based on a radio chain comprising low-resolution digital-to-analog converters (DACs) or low resolution analog-to-digital converters (ADCs), or both.

12. The base station of claim 1, wherein the at least one processor is configured to cause the base station to transmit an indication of the LR transmit condition of the first beam.

13. The base station of claim 12, wherein the indication comprises one or more of: information embedded in a payload of a physical control channel, information embedded in a payload of a physical data channel, a downlink control information, or a combination thereof.

14. The base station of claim 1, wherein the at least one processor is configured to cause the base station to indicate the LR transmit condition of the first beam.

15. The base station of claim 14, wherein the LR transmit condition is indicated by one or more of: a time-frequency resource associated with the first beam, a sequence type associated with the first signal, or a combination thereof.

16. The base station of claim 1, wherein the at least one processor is configured to cause the base station to transmit a configuration for a first set of transmit beams associated with the LR transmit condition, wherein the first set of transmit beams comprises the first beam.

17. The base station of claim 16, wherein the configuration indicates a first threshold for measurement and reporting of the first set of transmit beams associated with the LR transmit condition and a second threshold for measurement and reporting of a second set of transmit beams associated with the HR transmit condition, wherein the first threshold is different than the second threshold.

18. The base station of claim 16, wherein the configuration indicates a first criterion for ordering measurements associated with the first set of transmit beams and a second criterion for ordering measurements associated with the second set of transmit beams, and wherein the first criterion is different than the second criterion.

19. A method performed by a base station, the method comprising:
transmitting a first signal via a first beam; and
transmitting and a second signal via a second beam, the first beam associated with a low-resolution (LR) transmit condition and the second beam associated with a high-resolution (HR) transmit condition,
wherein:
the second signal is transmitted after the first signal is transmitted and the second beam is associated with the HR transmit condition based at least in part on a first response associated with the first signal, or
the first signal is transmitted after the second signal is transmitted and the first beam is associated with the LR transmit condition based at least in part on a second response associated with the second signal, or
the first signal and the second signal are transmitted simultaneously, the first beam is associated with the LR transmit condition based at least in part on the second beam being associated with the HR transmit condition or irrespective of whether the second beam is associated with the HR transmit condition.

20. A processor for wireless communication, comprising:
at least one controller coupled with at least one memory and configured to cause the processor to:
transmit a first signal via a first beam and a second signal via a second beam, the first beam associated with a low-resolution (LR) transmit condition and the second beam associated with a high-resolution (HR) transmit condition,
wherein the second signal is transmitted after the first signal is transmitted and the second beam is associated with the HR transmit condition based at least in part on a first response associated with the first signal, or
wherein the first signal is transmitted after the second signal is transmitted and the first beam is associated with the LR transmit condition based at least in part on a second response associated with the second signal, or
wherein the first signal and the second signal are transmitted simultaneously, the first beam is associated with the LR transmit condition based at least in part on the second beam being associated with the HR transmit condition or irrespective of whether the second beam is associated with the HR transmit condition.
